(19) United States
(12) Patent Application Publication
(10) Pub. No.: US 2003/0002080 A1
(43) Pub. Date: Jan. 2, 2003

(54) Identification of container for printing recording material

(76) Inventor: Noboru Asauchi, Nagano-ken (JP)

Correspondence Address: BEYER WEAVER & THOMAS LLP, P.O. BOX 778, BERKELEY, CA, 94704-0778, US

(21) Appl. No.: 10/181,584

(22) PCT Filed: Nov. 19, 2001
(86) PCT No.: PCT/JP01/10107

(30) Foreign Application Priority Data
Nov. 20, 2000 (JP) 2000-353244

(51) Int. Cl. B41B 1/00; G06F 15/00

(52) U.S. Cl. 358/1.16

(57) ABSTRACT

When a personal computer PC detects an ink exchange request, it identifies the ink cartridge CA1 whose exchange is requested. When ink cartridge CA1 is exchanged, personal computer PC transmits over data bus DB identifying data corresponding to identifying data held in the memory device 20 of the identified ink cartridge CA1. In the event that there is no response from the memory device of the exchanged ink cartridge CA, personal computer PC notifies to the effect that an incorrect ink cartridge CA is installed. In the event that there is a response from the memory device 20 of the exchanged ink cartridge CA1, personal computer PC determines that ink cartridge CA1 has been correctly installed.

### TECHNICAL FIELD

The present invention relates to a technique of identifying a printer recording material receptacle in a printing apparatus, and more particularly to a technique of identifying whether a printer recording material receptacle has been installed when replacing a printer recording material receptacle.

### BACKGROUND ART

In color printers comprising ink cartridges (printer recording material receptacles) of a multiplicity of colors, there have been proposed techniques to prevent erroneous installation of ink cartridges, i.e. installation of an ink cartridge of a different ink color than the one to be replaced, during ink cartridge replacement. For example, there is known the technique of varying the contour shape of ink cartridges for each ink color to physically prevent installation of an incorrect ink cartridge.

Where ink cartridges of identical contour shape are used, there is also known the technique of providing on the printer a cover having an opening through which only a single ink cartridge can be attached/detached, and moving the ink cartridge to be replaced to the opening to permit attachment/detachment of only the ink cartridge to be replaced.

However, where ink cartridges of different contour shape for each color are used, when ink cartridges are reused, ink cartridges can only be reused on a per-ink color basis, so there was the problem of bad recycling efficiency. Also, even if erroneous installation of ink cartridges could be prevented, it was not possible to prevent the problem of mistakenly uninstalling an ink cartridge not requiring replacement. Also, it was necessary to fabricate a different ink cartridge-use mold on a per-ink color basis, so there was the problem of high cost.

With the technique of moving ink cartridges to a predetermined replacement location, even if mistaken uninstallation of an ink cartridge not intended to be replaced could be prevented, it could not be detected whether an installed ink cartridge was the correct ink cartridge, so there was the problem of inability to prevent erroneous installation.

### DISCLOSURE OF THE INVENTION

The present invention was made to solve the aforementioned problems, and has as an object to prevent incorrect installation of printer recording material receptacles during replacement of printer recording material receptacles, without the use of contour-wise identifying shapes. It also has as an object to prevent mistakenly uninstalling printer recording material receptacles not requiring replacement.

To solve the aforementioned problems a first aspect of the invention provides an identifying device of a printer recording material receptacle having a memory device that stores identifying information and that is also installed in a printing device. The identifying device of a printer recording material receptacle pertaining to the first aspect of the present invention is characterized by comprising determining means that uses identifying information stored in said memory device to determine whether said installed printer recording material receptacle is the correct printer recording material receptacle to be installed.

According to the identifying device of a printer recording material receptacle pertaining to the first aspect of the present invention, identifying information stored in a memory device is utilized to determine whether an installed printer recording material receptacle is the correct printer recording material receptacle to be installed, so incorrect installation of a printer recording material receptacle can be detected during printer recording material receptacle replacement, without using contour-wise identifying shapes. It goes without saying that contour-wise identifying shapes are able to be used simultaneously.

The identifying device of a printer recording material receptacle pertaining to the first aspect of the present invention may further comprise notification means notifying to the effect that an incorrect printer recording material receptacle was installed, in the event of determination by said determining means that said installed printer recording material receptacle is not the correct printer recording material receptacle to be installed. When this arrangement is provided, it is possible to notify the user of installation of an incorrect printer recording material receptacle, and early installation of the correct printer recording material receptacle can be urged.

The identifying device of a printer recording material receptacle pertaining to the first aspect of the present invention may further comprise aspiration disabling means that disables aspiration of the printer recording material in a printer recording material receptacle until it has been determined by said determining means that said installed printer recording material receptacle is the correct printer recording material receptacle to be installed. When this arrangement is provided, when an incorrect printer recording material receptacle is installed, a drop in printed product quality caused by aspiration of incorrect printer recording material can be prevented before the fact.

In the identifying device of a printer recording material receptacle pertaining to the first aspect of the present invention, in said printing device a multiplicity of printer recording material receptacles may be respectively installed at predetermined installation locations, and said determining means, on the basis of identifying information of a memory device having installation location information relating a printer recording material receptacle to be installed at each said installation location and said installation location, and installed in said installed printer recording material receptacle and said installation location information, may determine whether said installed printer recording material receptacle is the correct printer recording material receptacle to be installed. When this arrangement is provided, it can be determined, on the basis of installation location information and identifying information when a printer recording material receptacle is installed, whether the correct printer recording material receptacle was installed.

In the identifying device of a printer recording material receptacle pertaining to the first aspect of the present invention, said determining means, using identifying information stored in said memory device, may in the event that uninstallation of said printer recording material receptacle was detected, identify said uninstalled printer recording material receptacle, and in the event that installation of said printer recording material receptacle is detected, use the identifying information of said installed printer recording material receptacle to determine whether said installed printer recording material receptacle is a printer recording material receptacle containing printer recording material identical to or interchangeable with said uninstalled printer recording material receptacle. In this case, it can be determined whether the correct printer recording material receptacle has been installed, not only when a printer recording material receptacle is the same as the uninstalled printer recording material receptacle, but also when a printer recording material receptacle interchangeable with said uninstalled printer recording material receptacle is used.

In the identifying device of a printer recording material receptacle pertaining to the first aspect of the present invention, said determining means, with a multiplicity of printer recording material receptacles installed in said printing device, and using identifying information stored in said memory device, in the event that uninstallation of said printer recording material receptacle was detected, may identify said uninstalled printer recording material receptacle, and in the event that installation of said printer recording material receptacle is detected, identify said installed printer recording material receptacle, and on the basis of that designation result, determine whether said installed printer recording material receptacle is a printer recording material receptacle that contains a printer recording material identical to said uninstalled printer recording material receptacle. When this arrangement is provided, it can be determined whether the correct printer recording material receptacle has been installed, on the basis of identifying information of the uninstalled printer recording material receptacle and identifying information of the installed printer recording material receptacle, even if installation location information cannot be had.

In the identifying device of a printer recording material receptacle pertaining to the first aspect of the present invention, memory devices provided to said multiplicity of printer recording material receptacles may respond only in the event of having received an identifying signal corresponding to stored identifying information, and said determining means may, after detecting uninstallation of said printer recording material receptacle, transmit to each said memory device an identifying signal corresponding to all identifying information, and identify the printer recording material receptacle equipped with the unresponsive memory device as the printer recording material receptacle that has been uninstalled, and after installation of said printer recording material receptacle has been detected, transmit to each said memory device an identifying signal corresponding to identifying information stored in said unresponsive memory device, and when a response is obtained, determine that the correct printer recording material receptacle has been installed. When this arrangement is provided, it can be determined whether or not the correct printer recording material receptacle has been installed, depending on whether there is a response from the memory device provided to a printer recording material receptacle. Also, it becomes possible using identifying information to detect erroneous uninstallation of a printer recording material receptacle that should not be replaced, and as a result to prevent erroneous uninstallation of printer recording material receptacles.

In the identifying device of a printer recording material receptacle pertaining to the first aspect of the present invention, said determining means may transmit to each said memory device an identifying signal corresponding to identifying information stored in said unresponsive memory device, and in the event that there is no response, determine that an incorrect printer recording material receptacle was installed.

The identifying device of a printer recording material receptacle pertaining to the first aspect of the present invention may further comprise a memory device detection signal line connected in cascade to each said memory device with one end thereof grounded and the other end thereof connected to memory device detection voltage, and attachment/detachment detecting means that detects attachment/detachment of a printer recording material receptacle based on the value of said memory device detection signal line. In this case, attachment/detachment of a printer recording material receptacle can be detected on the basis of the value of the detection voltage.

A second aspect of the present invention provides an identification method of a printer recording material receptacle that comprises a memory device storing identifying information corresponding to a type of printer recording material, and that is installed in a printing device. The identification method of a printer recording material receptacle pertaining to the second aspect of the present invention is characterized in that uninstallation of said printer recording material receptacle is detected, using identifying information stored in said memory device, the type of printer recording material of said uninstalled printer recording material receptacle is identified, installation of said printer recording material receptacle is detected, using identifying information stored in said memory device, the type of printer recording material of said uninstalled printer recording material receptacle is identified, and on the basis of the identification result of the type of printer recording material of said installed printer recording material receptacle and the identification result of the type of printer recording material of said uninstalled printer recording material receptacle, it is determined whether the correct printer recording material receptacle was installed.

According to the identification method of a printer recording material receptacle pertaining to the second aspect of the present invention, it can be determined, using identifying information stored in a memory device, whether an installed printer recording material receptacle is the correct printer recording material receptacle to be installed, so that incorrect installation of a printer recording material receptacle can be detected during printer recording material receptacle replacement, without the use of contour-wise identifying shapes.

In the identification method of a printer recording material receptacle pertaining to the second aspect of the present invention, in the event that the type of printer recording material of said installed printer recording material receptacle and the type of printer recording material of said uninstalled printer recording material receptacle are identical or of interchangeable type, it may be determined that the correct printer recording material receptacle has been installed. Also, in the event that the type of printer recording material of said installed printer recording material receptacle and the type of printer recording material of said uninstalled printer recording material receptacle are different, it may be determined that an incorrect printer recording material receptacle has been installed, and notification made of installation of an incorrect printer recording material receptacle.

In the identification method of a printer recording material receptacle pertaining to the second aspect of the present invention, aspiration of the printer recording material in said printer recording material receptacle may be disabled until it has been determined whether said installed printer recording material receptacle is the correct printer recording material receptacle to be installed. When this arrangement is provided, when an incorrect printer recording material receptacle is installed, a drop in printed product quality caused by aspiration of incorrect printer recording material can be prevented before the fact.

A third aspect of the present invention provides an identification method of a printer recording material receptacle comprising a memory device storing identifying information corresponding to a type of printer recording material and installed at a predetermined location on a printing device with reference to said type of printer recording material. The identification method of a printer recording material receptacle pertaining to the third aspect of the present invention may detect uninstallation of said printer recording material receptacle, remember the installation location at which said uninstalled printer recording material receptacle was installed, detect installation of said printer recording material receptacle, use identifying information stored in said memory device to identify the type of printer recording material of said installed printer recording material receptacle, and on the basis of the installation location of said installed printer recording material receptacle and the type of printer recording material of said installed printer recording material receptacle, determine whether the correct printer recording material receptacle was installed.

According to the identification method of a printer recording material pertaining to the third aspect of the present invention, by using the installation location of an uninstalled printer recording material receptacle and identifying information stored in a memory device, it is determined whether an installed printer recording material receptacle is the correct printer recording material receptacle to be installed, so incorrect installation of a printer recording material receptacle during printer recording material receptacle replacement can be detected without the use of contour-wise identifying shapes.

In the identification method of a printer recording material pertaining to the third aspect of the present invention, in the event of a determination that an incorrect printer recording material receptacle was installed, notification may be made of installation of an incorrect printer recording material receptacle.

A fourth aspect of the present invention provides a computer-readable medium storing a program monitoring exchange of a printer recording material receptacle that comprises a memory device storing identifying information corresponding to a type of printer recording material, and that is installed at a predetermined location on a printing device with reference to the type of printer recording material. The computer-readable medium pertaining to the fourth aspect of the present invention comprises a program that executes by means of a computer a function of detecting uninstallation of said printer recording material receptacle, a function of remembering the installation location at which said uninstalled printer recording material receptacle was installed, a function of detecting installation of said printer recording material receptacle, a function of using identifying information stored in said memory device to identify the type of printer recording material of said installed printer recording material receptacle, and a function of, on the basis of the installation location of said installed printer recording material receptacle and the type of printer recording material of said installed printer recording material receptacle, determining whether the correct printer recording material receptacle was installed.

According to the computer-readable medium pertaining to the fourth aspect of the present invention, there can be obtained effects similar to the method of identifying a printer recording material receptacle pertaining to the second aspect of the present invention.

A fifth aspect of the present invention provides a printer recording material receptacle exchange control device in a printing device having installed therein a multiplicity of printer recording material receptacles having memory devices storing identifying information corresponding to the type of printer recording material contained therein. The printer recording material receptacle exchange control device pertaining to the fifth aspect of the present invention is characterized by comprising exchange request detecting means that detects an exchange request of a printer recording material, printer recording material receptacle moving means that moves the printer recording material receptacle containing the printer recording material whose replacement was requested to a replacement location, attachment/detachment detecting means that detects uninstallation of said printer recording material receptacle that has been moved to said replacement location, as well as installation of a printer recording material receptacle subsequent to uninstallation, and determining means that uses said identifying information to determine whether said installed printer recording material receptacle is the correct printer recording material receptacle containing the printer recording material whose replacement was requested.

According to the printer recording material receptacle exchange control device pertaining to the fifth aspect of the present invention, identifying information stored in a memory device is used to determine whether an installed printer recording material receptacle is the correct printer recording material receptacle, so incorrect installation of a printer recording material receptacle during printer recording material receptacle replacement can be detected, without the use of contour-wise identifying shapes.

In the printer recording material receptacle exchange control device pertaining to the fifth aspect of the present invention, said printing device may have printing means that prints using said printer recording material, and expelling means that expels said printer recording material held by said printing means, said correct printer recording material receptacle may include a printer recording material receptacle that contains a printer recording material identical to or interchangeable with said printer recording material whose replacement was requested, and the exchange control device of said printer recording material receptacle may further comprise exchange-time expelling means that, in the event of a determination by said determining means that a printer recording material receptacle containing a printer recording material interchangeable with said installed printer recording material has been installed, expels by means of said expelling means the printer recording material held by said printing means. In this case, even if an interchangeable printer recording material receptacle is used, mixing of the printer recording material of a printer recording material receptacle whose replacement was requested and the printer recording material of an interchangeable printer recording material receptacle may be prevented. Thus, correct printing results can be obtained.

In the printer recording material receptacle exchange control device pertaining to the fifth aspect of the present invention, said printer recording material receptacle moving means may identify a printer recording material receptacle containing a printer recording material whose replacement was requested using identifying information stored in said memory device and/or installation location information of said printer recording material receptacle.

In the printer recording material receptacle exchange control device pertaining to the fifth aspect of the present invention, the memory devices provided to said multiplicity of printer recording material receptacles may respond only when receiving identifying information that matches stored identifying information, and said determining means may, after uninstallation of a said printer recording material receptacle has been detected, transmit to each said memory device an identifying signal corresponding to all identifying information, and identify the printer recording material receptacle equipped with the unresponsive memory device as the printer recording material receptacle that has been uninstalled, and after installation of said printer recording material receptacle has been detected, transmit to each said memory device an identifying signal corresponding to identifying information stored in said unresponsive storage, and when a response is obtained, determine that the correct printer recording material receptacle has been installed. When this arrangement is provided, it can be determined whether or not the correct printer recording material receptacle has been installed, depending on whether there is a response from the memory device provided to the printer recording material receptacle. Also, it becomes possible using identifying information to detect incorrect uninstallation of a printer recording material receptacle that should not be replaced, and as a result to prevent incorrect uninstallation of printer recording material receptacles.

In the printer recording material receptacle exchange control device pertaining to the fifth aspect of the present invention, said printing device may comprise in said replacement location an attachment/detachment restricting mechanism that enables attachment/detachment only of a printer recording material receptacle containing a printer recording material receptacle whose replacement was requested. Said attachment/detachment restricting mechanism may be a cover having a replacement opening. Where such an arrangement is provided, incorrect uninstallation of a printer recording material receptacle can be prevented by means of a physical mechanism.

The printer recording material receptacle exchange control device pertaining to the fifth aspect of the present invention may further comprise notifying means that in the event it is determined that said installed printer recording material receptacle is not the correct printer recording material receptacle, notifies to the effect that an incorrect printer recording material receptacle was installed.

The printer recording material receptacle exchange control device pertaining to the fifth aspect of the present invention may further comprise a memory device detection signal line connected in cascade to each said memory device with one end thereof grounded and the other end thereof connected to memory device detection voltage, and said attachment/detachment detecting means may detect attachment/detachment of a printer recording material receptacle based on the value of said memory device detection signal line.

In the printer recording material receptacle exchange control device pertaining to the fifth aspect of the present invention, there may be provided aspiration disabling means that disables aspiration of the printer recording material in a printer recording material receptacle until it has been determined whether said installed printer recording material receptacle is the correct printer recording material receptacle to be installed. When this arrangement is provided, when an incorrect printer recording material receptacle is installed, a drop in printed product quality caused by aspiration of incorrect printer recording material can be prevented before the fact.

A sixth aspect of the present invention provides a printer recording material receptacle exchange control device in a printing device having installed therein a multiplicity of printer recording material receptacles having memory devices storing identifying information corresponding to the type of printer recording material contained therein. The printer recording material receptacle exchange control device pertaining to the sixth aspect of the present invention is characterized by comprising exchange request detecting means that detects printer recording material exchange requests, indicating means that shows the printer recording material receptacle containing the printer recording material whose replacement was requested, attachment/detachment detecting means that detects uninstallation of said printer recording material receptacle shown by said indicating means and that detects installation of a printer recording material receptacle following uninstallation, and determining means that uses said identifying information to determine whether said inserted printer recording material receptacle is the correct printer recording material receptacle containing the printer recording material whose replacement was requested.

According to the printer recording material receptacle exchange control device pertaining to the sixth aspect of the present invention, there is provided indicating means that shows the printer recording material receptacle containing the printer recording material whose replacement was requested, so the printer recording material receptacle to be replaced can be made definite.

In the printer recording material receptacle exchange control device pertaining to the sixth aspect of the present invention, said printing device may have an exchange location at which said printer recording material receptacle is exchanged, and said indicating means may be arranged at said exchange location in said printing device. In this case, since the indicating means is arranged at said replacement location, the printer recording material receptacle to be replaced may be grasped easily. Also, said printing device may have a carriage on which said printer recording material receptacle is mounted, and said indicating means may be arranged at a location corresponding to the mounting location of said printer recording material receptacle in said carriage. In this case, since the indicating means is arranged at a location corresponding to the mounting location of each printer recording material receptacle in the carriage, the printer recording material receptacle to be replaced can be indicated appropriately regardless of carriage position.

A seventh aspect of the present invention provides an exchange control method of printer recording material receptacles in a printing device having a multiplicity of printer recording material receptacles installed therein. The printer recording material receptacle exchange control method pertaining to the seventh aspect of the present invention is characterized in that an exchange request of a printer recording material is detected, the printer recording material receptacle containing said printer recording material whose replacement was requested is moved to an exchange location, uninstallation of said printer recording material receptacle moved to said exchange location is detected and installation of a printer recording material receptacle following uninstallation is detected, and using identifying information corresponding to the type of printer recording material contained in said printer recording material receptacle, it is determined whether said installed printer recording material receptacle is the correct printer recording material receptacle containing the printer recording material whose replacement was requested.

According to the printer recording material receptacle exchange control method pertaining to the seventh aspect of the present invention, there may be obtained effects similar to the printer recording material receptacle exchange control device pertaining to the fifth aspect of the invention.

In the printer recording material receptacle exchange control method pertaining to the seventh aspect of the present invention, said correct printer recording material receptacle may include a printer recording material receptacle containing a printer recording material identical to or interchangeable with said printer recording material whose replacement was requested, and in the event of a determination that a printer recording material receptacle containing a printer recording material interchangeable with said installed printer recording material has been installed, additionally, printer recording material held by printing means that performs printing using said printer recording material may be expelled. In this case, it is possible to prevent mixing of printer recording material of a printer recording material receptacle whose replacement was requested and printer recording material of an interchangeable printer recording material receptacle. Thus, it is possible to obtain correct printing results.

In the printer recording material receptacle exchange control method pertaining to the seventh aspect of the present invention, the printer recording material receptacle containing said printer recording material receptacle whose replacement was requested may be identified using identifying information stored in said memory device and/or installation location information of said printer recording material receptacle.

An eighth aspect of the present invention provides a computer readable storage medium that stores a program of exchange control of printer recording material receptacles in a printing device having a multiplicity of printer recording material receptacles installed therein. The computer readable storage medium pertaining to the eighth aspect of the present invention comprises a computer program that executes by means of a computer a function of detecting an exchange request of a printer recording material, a function of moving the printer recording material receptacle containing said printer recording material whose replacement was requested to a replacement location, a function of detecting uninstallation of said printer recording material receptacle moved to said replacement location and detecting installation of a printer recording material receptacle following uninstallation, and a function of using identifying information corresponding to the type of printer recording material contained in said printer recording material receptacle to determine whether said installed printer recording material receptacle is the correct printer recording material receptacle containing the printer recording material whose replacement was requested.

According to the computer readable storage medium pertaining to the eighth aspect of the present invention, there may be obtained effects similar to the printer recording material receptacle exchange control device pertaining to the fifth aspect of the invention.

In the computer readable storage medium pertaining to the eighth aspect of the present invention, said correct printer recording material receptacle may include a printer recording material receptacle containing a printer recording material receptacle identical to or interchangeable with said printer recording material whose replacement was requested, and a function that in the event of a determination that a printer recording material receptacle containing a printer recording material interchangeable with said installed printer recording material has been installed, additionally, eliminates printer recording material held by printing means that performs printing using said printer recording material may be executed by means of a computer. In this case, it is possible to prevent mixing of printer recording material of a printer recording material receptacle whose replacement was requested and printer recording material of an interchangeable printer recording material receptacle, even if a printer recording material receptacle whose replacement was requested is used. Thus, it is possible to obtain correct printing results.

### BRIEF DESCRIPTION OF THE DRAWINGS

FIG. 1 is an explanatory diagram showing a simplified arrangement of a color printer in which the printer recording material receptacle identifying device pertaining to Embodiment 1 may be embodied.

FIG. 2 is a block diagram showing a simplified arrangement of the color printer pertaining to Embodiment 1.

FIG. 3 is an explanatory diagram showing the internal arrangement of the control circuit 30 of color printer 10.

FIG. 4 is a block diagram showing interconnections between a personal computer PC and memory devices provide to ink cartridges.

FIG. 5 is an explanatory diagram showing an example of memory devices implemented in ink cartridges.

FIG. 6 is an explanatory diagram showing an example of a data sequence transmitted from a personal computer PC to memory devices 20, 21, 22, 23.

FIG. 7 is a block diagram showing the internal circuit arrangement of memory devices 20, 21, 22, 23.

FIG. 8 is a flow chart showing a typical processing routine executed by a personal computer PC when accessing memory devices 20, 21, 22, 23 of ink cartridges CA1-CA4.

FIG. 9 is a timing chart showing temporal relationships of the reset signal RST, clock signal SCK, data signal CDA, and address counter value when reading data.

FIG. 10 is a timing chart showing temporal relationships of the reset signal RST, clock signal SCK, data signal CDA, and address counter value when writing data.

FIG. 11 is a flow chart showing a processing routine of an ink cartridge identifying process performed during initial ink cartridge installation.

FIG. 12 is an explanatory diagram showing movement of ink cartridges CA1-CA4 during ink cartridge replacement.

FIG. 13 is an explanatory diagram showing movement of ink cartridges CA1-CA4 during ink cartridge replacement.

FIG. 14 is an explanatory diagram showing movement of ink cartridges CA1-CA4 during ink cartridge replacement.

FIG. 15 is a flow chart showing a processing routine performed during an ink cartridge identifying process pertaining to Embodiment 2.

FIG. 16 is a flow chart showing a processing routine performed during an ink cartridge identifying process pertaining to Embodiment 3.

FIG. 17 is a flow chart showing a processing routine performed during an ink cartridge identifying process in FIG. 16.

FIG. 18 is an explanatory diagram showing interconnects of the control circuit and memory devices used in the ink cartridge identifying device pertaining to Embodiment 4.

FIG. 19 is a flow chart showing a processing routine performed during an ink cartridge identification exchange process pertaining to Embodiment 5.

FIG. 20 is an explanatory diagram showing the upper cover 17 of a color printer 10 with a Y indicating the ink cartridge CA to be replaced.

FIG. 21 is an explanatory diagram showing a carriage 101′ comprising an LED that indicates the ink cartridge CA to be replaced.

### DETAILED DESCRIPTION OF THE PREFERRED EMBODIMENTS

The printer recording material receptacle identifying device pertaining to the invention is described in the following order on the basis of some embodiments, while referring to the drawings.

A. Arrangement of Ink Cartridge (Printer Recording Material Receptacle) Identifying Device Pertaining to Embodiment 1

B. Arrangement of Memory Devices Pertaining to Embodiment 1

C. Operation of Ink Cartridge Identifying Device Pertaining to Embodiment 1

D. Ink Cartridge Identifying Process Pertaining to Embodiment 2

E. Ink Cartridge Identifying Process Pertaining to Embodiment 3

F. Ink Cartridge Identifying Device Pertaining to Embodiment 4

G. Ink Cartridge Identification Replacement Process Pertaining to Embodiment 5

A. Arrangement of Printer Recording Material Receptacle Identifying Device Pertaining to Embodiment 1

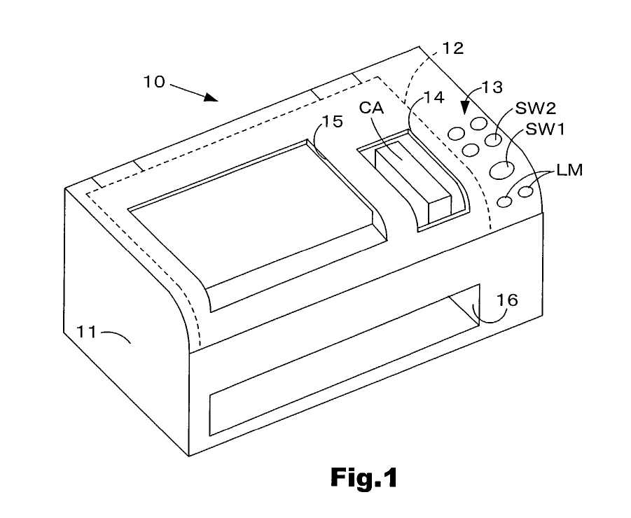

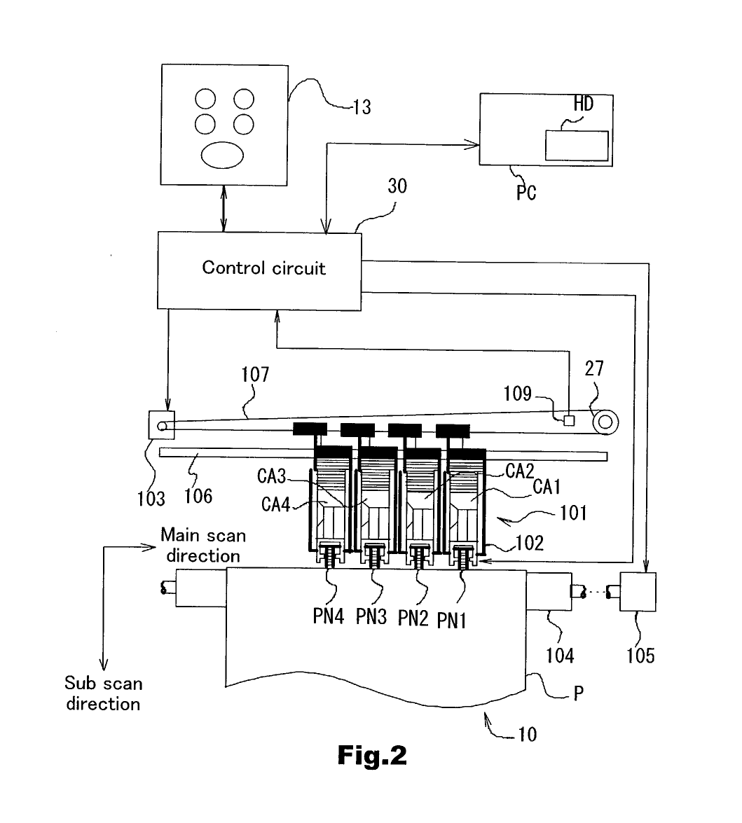

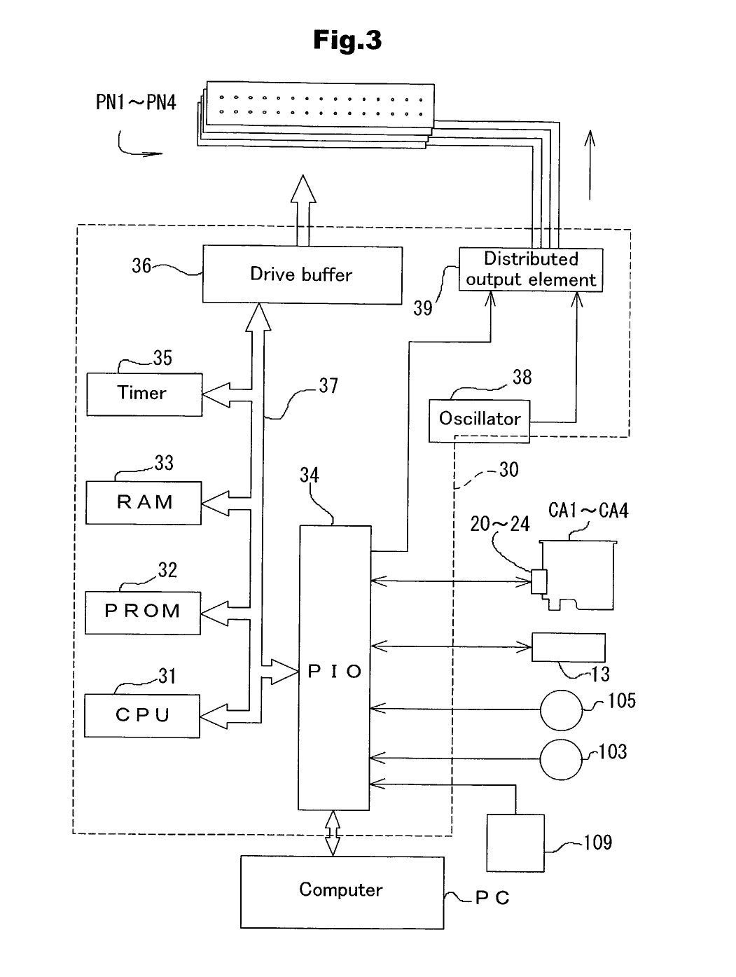

Referring to FIG. 1-FIG. 3, a simplified arrangement of a printer recording material receptacle identifying device pertaining to Embodiment 1 is explained. FIG. 1 is an explanatory diagram showing a simplified arrangement of a color printer in which the printer recording material receptacle identifying device pertaining to Embodiment 1 may be embodied. FIG. 2 is a block diagram showing a simplified arrangement of the color printer pertaining to Embodiment 1. FIG. 3 is an explanatory diagram showing the internal arrangement of the control circuit 30 of color printer 10.

The printer recording material receptacle (ink cartridge) identifying device pertaining to this embodiment is realized on an ink jet type color printer (printing device) 10. Color printer 10 is a printer capable of color image output, an ink jet type printer that ejects colored inks of, for example, the four colors cyan (C), magenta (M), yellow (Y), and black (K) onto a print medium to produce a dot pattern. As colored inks, in addition to the above four colors, there may be used light cyan (LC), light magenta (LM), and dark yellow (DY). While in this embodiment a color ink-jet printer is used in the description, an electrophotographic printer that transfers and fixes colored toner onto a print medium to produce an image could be used as well.

As shown in FIG. 1, color printer 10 comprises a main body 11 housing the print function portion, and a cover 12 indicated by broken lines, that is opened and closed when replacing ink cartridges CA. On the upper face of the main body 11 there are provided a control panel 13 equipped with a power switch SW1, an ink cartridge replacement switch SW2, an indicator lamp LM etc.; a replacement opening that is used during ink cartridge replacement to attach/detach ink cartridges CA; and a maintenance opening 15. On the front face of the main body 11 is provided a paper discharge orifice 16 through which printed paper is discharged after being supplied from a paper feed orifice, not shown. A multiplicity of ink cartridge replacement switches SW2, assigned to individual ink cartridges CA, may be provided, or only a single one provided.

As shown in FIG. 2, color printer 10 comprises a mechanism that drives a print head 102 mounted on a carriage 101 and performs ejection of ink and formation of dots; a mechanism that reciprocates this carriage 101 in the axial direction of a platen 104 by means of a carriage motor 103; a mechanism that feeds printer paper P by means of a paper feed motor 105; and a control circuit 30. The mechanism that reciprocates the carriage 101 in the axial direction of platen 104 comprises a slide rail 106 that extends parallel to platen 104 and slidably retains carriage 101; a pulley 108 linked by means of an endless drive belt 107 to the carriage motor 103, a position detection sensor 109 that detects the home position of carriage 101, and the like. The mechanism that feeds printer paper P comprises a platen 104, a paper feed motor 105 that rotates platen 104, an auxiliary paper feed roller, not shown, and a gear train (not shown) that transmits rotation of the paper feed motor 105 to platen 104 and the auxiliary paper feed roller.

Control circuit 30 performs appropriate control of operation of paper feed motor 105, carriage motor 103 and print head 102 while exchanging signals with the control panel 13 of the printer. Printer paper P supplied to printer 10 is set so as to be pinched between platen 104 and the auxiliary paper feed roller, and advanced in predetermined amounts depending on the rotation angle of platen 104. Control circuit 30 is connected to a personal computer PC. Personal computer PC executes an ink cartridge identifying process, described later, on the basis of a program stored in an internal or external memory device (storage medium) HD, and transmits control signals to control circuit 30. In this embodiment, control circuit 30 controls operation of the parts of printer 10 following control signals received from personal computer PC.

On carriage 101 are mounted ink cartridges CA1-CA8. Ink cartridge CA1 contains, for example, black (K) ink, ink cartridge CA2 cyan (C) ink, ink cartridge CA3 magenta (M) ink, and ink cartridge CA4 yellow (Y) ink. As stated above, in addition to these, ink cartridges CA of light cyan (LC) ink, light magenta (LM) ink and dark yellow (DY) ink may be installed as well.

The internal arrangement of control circuit 30 is described referring to FIG. 3. Control circuit 30 comprises a CPU 31; PROM 32; RAM 33; memory devices provided to ink cartridges CA1-CA4; a peripheral input/output portion (PIO) 34 that exchanges data with paper feed motor 105, carriage motor 103 etc.; a timer 35; a drive buffer 36 etc. Drive buffer 36 is used as a buffer for supplying dot ON/OFF signals to ink eject heads PN1-PN4. These are interconnected by means of a bus 37 to enable data exchange among them. Control circuit 30 additionally comprises an oscillator 38 that outputs a drive waveform of predetermined frequency, and a distributed output element 39 that distributes the output from oscillator 38 to ink eject heads PN1-PN4 at predetermined timing.

Control circuit 30, during ink cartridge CA replacement, identifies whether a uninstalled ink cartridge and a newly installed ink cartridge contain the same ink type. Control circuit 30, while synchronizing with operation of paper feed motor 105 and carriage motor 103, outputs dot data to drive buffer 37 at predetermined timing. The detailed flow of the ink cartridge identifying process performed by control circuit 30 is explained hereinbelow.

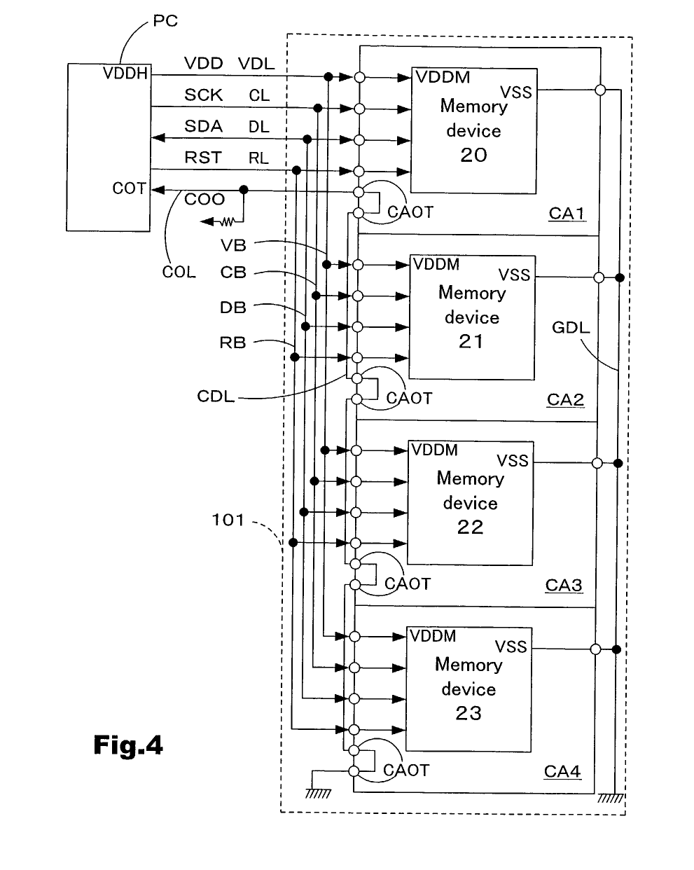

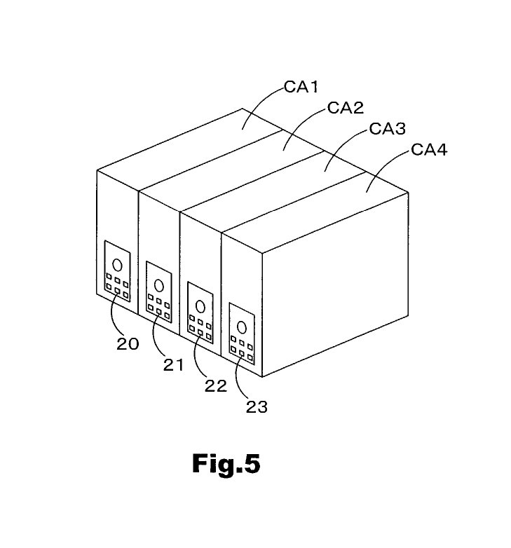

Next, referring to FIG. 4 and FIG. 5, interconnections of the personal computer PC and the memory devices provided to the ink cartridges is described. FIG. 4 is a block diagram showing interconnections between a personal computer PC and memory devices provide to ink cartridges. FIG. 5 is an explanatory diagram showing an example of memory devices implemented in ink. In FIG. 4, to simply explanation, memory devices 20, 21, 22, 23 and ink cartridges CA1, CA2, CA3, CA4 are merely depicted generically, and the ink cartridge identifying device pertaining to this embodiment is not limited to the arrangement shown in FIG. 4.

As shown in FIG. 5 the memory devices 20, 21, 22, 23 are respectively provided to ink jet printer ink cartridges CA1, CA2, CA3, CA4 of four colors. The ink cartridges CA1, CA2, CA3, CA4 of four colors respectively contain black (K) Ink, cyan (C) ink, magenta (M) ink and yellow (Y) ink. In this embodiment, as the memory devices, EEPROM, which holds stored contents in nonvolatile manner as well as allowing stored contents to be rewritten, is used.

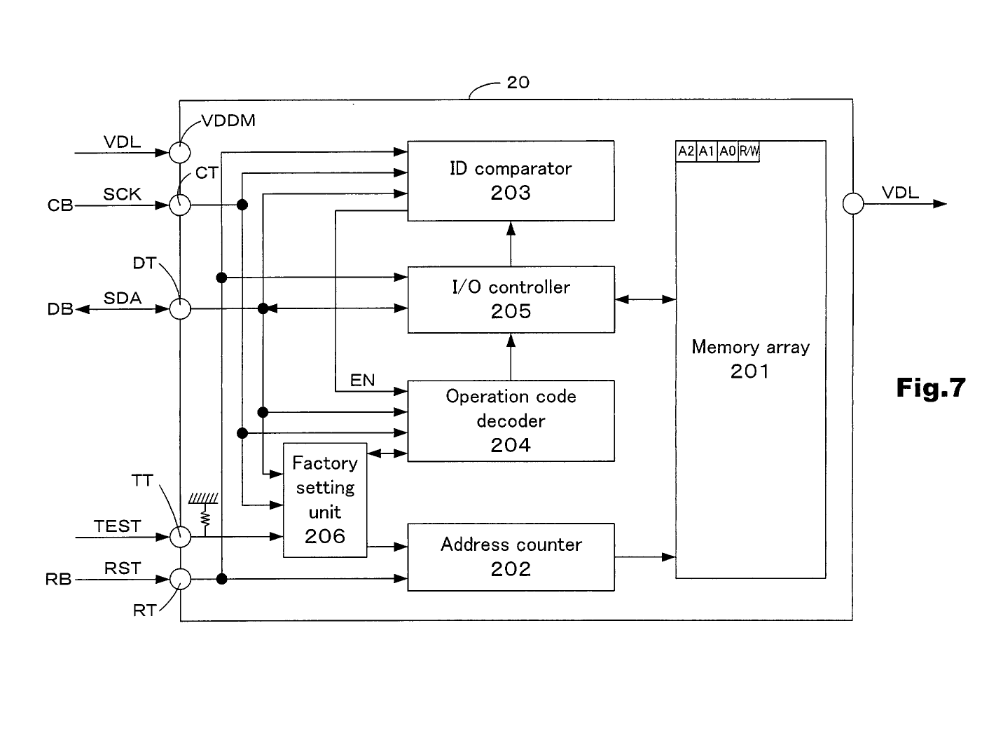

The data signal terminals DT, clock signal terminals CT, and reset signal terminals RT of memory devices 20, 21, 22, 23 are respectively connected to a data bus DB, a clock bus CB, and a reset bus RB (see FIG. 4 and FIG. 7). Personal computer PC and data bus DB, clock bus CB, and reset bus RB are connected via a data signal line DL, clock signal line CL, and reset signal line RL. These signal lines are realized as flexible feed cable (FFC), for example. The positive power terminal VDDH of personal computer PC and the positive power terminals VDDM of memory devices 20, 21, 22, 23 are connected via a power supply line VDL. The negative power terminals VSS of memory devices 20, 21, 22, 23 are connected to a ground line GDL on carriage 101. On carriage 101 is arranged a cartridge out detection line CDL to which cartridge out detection terminals CAOT provided to ink cartridges CA1-CA4 are connected in a cascade. One terminal of cartridge out detection line CDL is grounded, while the other terminal is connected via a cartridge out signal line COL to the cartridge out detection terminal COT of personal computer PC.

In this embodiment, since a dedicated ground line GDL is connected to the negative power terminals VSS of storage devices 21-23, any of the storage devices 21-23 can be accessed by personal computer PC even if not all of the ink cartridges CA1-CA4 are installed. This arrangement is particularly useful during initial installation of ink cartridges CA, or when simultaneously replacing a multiplicity of ink cartridges CA.

Control circuit 30 is a controller device that, via CPU 31, performs a clock signal generating function, a reset signal generating function, a power monitoring function, and control functions that control the power circuit, backup power circuit, data storage circuit and various circuits, and also controls access to memory devices 20, 21, 22, 23. Control circuit 30 is located on the main body side of color printer 10, and when powered on acquires data, namely, ink consumption amount and ink cartridge installation time, from the memory devices 20, 21, 22, 23, and stores this in a data storage circuit. When powered off, it writes data, namely ink consumption amount and ink cartridge installation time, to memory devices 20, 21, 22, 23.

Control circuit 30 accesses memory devices 20, 21, 22, 23 when the ink jet printer is powered on, when ink cartridges are replaced, when a print job is completed, when the ink jet printer experiences power interruption, and so on. When accessing memory devices 20, 21, 22, 23, control circuit 30 requests the reset signal generating circuit to generate a reset signal. Thus, a reset signal will be generated also in the event of a power outage, or if the power plug is unplugged. CPU 31 controls the backup power circuit to supply power for a predetermined time interval (0.3 s, for example) even if the power supply should be interrupted. As a result, even if the power should be interrupted while data is being written due to a power outage or the power plug being unplugged, during the aforementioned time interval it will be possible to complete writing of data assigned priority of writing. The backup power circuit may consist of a capacitor, for example.

Control circuit 30 controls the power circuit to output positive power. The control circuit 30 of this embodiment does not normally supply power to memory devices 20, 21, 22, 23, but rather supplies positive power to memory devices 20, 21, 22, 23 only in the event that there is an access request to a memory device 20, 21, 22, 23.

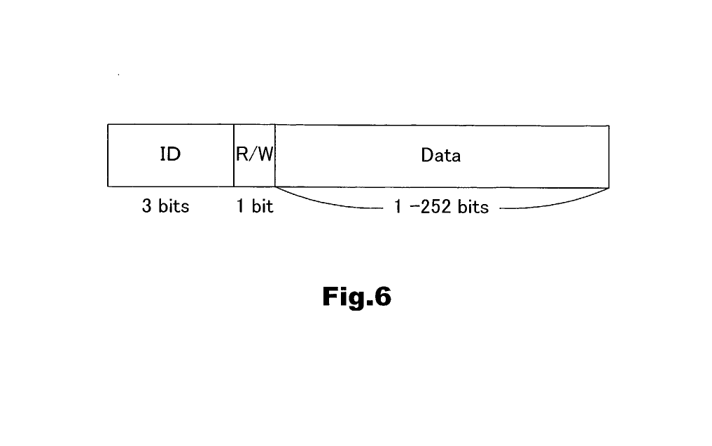

A data sequence transmitted from personal computer PC is described referring to FIG. 6. FIG. 6 is an explanatory diagram showing an example of a data sequence transmitted from a personal computer PC to memory devices 20, 21, 22, 23.

The data sequence transmitted from personal computer PC, as shown in FIG. 7, comprises a 3-bit identifying data portion, a 1-bit read/write command portion, and a 1-252-bit write/read data portion. Where data is to be read from a memory device 20, 21, 22, 23, personal computer PC controls the clock signal generating circuit of control circuit 30 to generate a clock signal SCK at intervals of 4 μS, for example, and where data is to be written, generates a clock signal SCK at intervals of 3 ms.

B. Arrangement of Memory Devices Pertaining to Embodiment 1

The internal arrangement of memory devices 20, 21, 22, 23 is described referring to FIG. 7. FIG. 7 is a block diagram showing the internal circuit arrangement of memory device 20. As the internal arrangement of each individual memory device 20, 21, 22, 23 is similar, apart from the identifying information (identifying data) and unique data stored therein, the following description will focus on the internal arrangement of memory device 20 as representative.

Memory device 20 comprises a memory array 201, address counter 202, ID comparator 203, operation code decoder 204, I/O controller 205 and factory setting unit 206.

Memory array 201 has a memory area of predetermined capacity, for example, 256 bits. Identifying data is stored in the head 3 bits of the memory area, and the memory area of the fourth bit from the head is a null area. As noted above, the head 3 bits of a data sequence sent from CPU 31 store identifying data, and the fourth bit from the head stores a write/read command. Therefore, data cannot be written unless it is to the memory area of the fifth and subsequent bits from the head, and by providing this arrangement to the memory area of memory array 201, the head four bits constitute a read-only memory area. Memory array 201 has an area starting at the fifth bit from the head where information to be given priority of writing, for example, information relating to ink consumption or remaining ink, is written.

Address counter 202 is a circuit that increments the counter value in sync with a clock signal SCK supplied via factory setting unit 206, and is connected to memory array 201. Counter values and memory locations (addresses) of memory array 201 are associated, and a write location or read location in memory array 201 can be indicated by a counter value in address counter 202. Address counter 202 is also connected with reset signal terminal RT, and when a reset signal RST is input the counter value is reset to the initial value. Here, the initial value may be any value provided it is associated with the head location of memory array 201; typically 0 is used as the initial value.

ID comparator 203 is connected to clock signal terminal CT, data signal terminal DT and reset signal terminal RT, and determines whether identifying data included in a data sequence input via data signal terminal DT and identifying data stored in memory array 201 match. To describe in more detail, ID comparator 203 acquires 3 bits of data, i.e. identifying data, after a reset signal RST has been input. ID comparator 203 has a 3-bit register (not shown) that stores identifying data included in the data sequence and a 3-bit register (not shown) that stores identifying data acquired from memory array 201 via I/O controller 205, and determines whether identifying data matches depending on whether the values in the two registers match. ID comparator 203, in the case that the two identifying data match, transmits an access enable signal EN to operation code decoder 204. ID comparator 203 clears the values in the registers when a reset signal RST is input.

Operation code decoder 204 is connected to I/O controller 205, clock signal terminal CT, and data signal terminal DT, and acquires the data of the fourth bit after input of a reset signal RST, that is, a write/read command. Operation code decoder 204, when an access enable signal EN is input, analyzes the acquired write/read command and transmits a write operation request or read operation request to I/O controller 205. Operation code decoder 204 is also connected to factory setting unit 206, and in test mode upon completing analysis of a write/read command transmits an analysis completed notification to factory setting unit 206.

I/O controller 205 is connected to data signal terminal DT and memory array 201, and in accordance with a request from operation code decoder 204 performs switching control of data transfer direction vis-à-vis memory array 201 and data transfer direction vis-à-vis data signal terminal DT (the signal line connected to data signal terminal DT). I/O controller 205 is also connected to reset terminal RT, and receives reset signals RST. I/O controller 205 has a first buffer memory (not shown) that temporarily stores data read from memory array 201 and data to be written to memory array 201, and a second buffer memory (not shown) that temporarily stores data from data bus DB and data going to data bus DB.

I/O controller 205 is initialized by input of a reset signal RST, and during initialization sets the data transfer direction vis-à-vis memory array 201 to the read direction, and brings the signal line connected to data signal terminal DT to high impedance, disabling data transfer vis-à-vis data signal terminal DT. The state at the time of initialization is maintained until a write operation request or read operation request is input from operation code decoder 204. Accordingly, data of the head 4 bits of a data sequence input via data signal terminal DT after reset signal input is not written in memory array 201, whereas data stored in the head 4 bits of memory array 201 (of which the 4th bit is null data) is transmitted to ID comparator 203. As a result, the head 4 bits of memory array 201 are read-only.

Factory setting unit 206 is connected to a test signal terminal TT, clock signal terminal CT, and data signal terminal DT, and when a test signal is input executes a test mode process. Factory setting unit 206 in the absence of input of a test signal transfers the received clock signal SCK as-is to the address counter 202, and in the presence of a test signal does not transfer the clock signal SCK to the address counter 202 until receiving an analysis completion notification from operation code decoder 204. Factory setting unit 206 transmits test mode commands to operation code decoder 204. Test signal terminal TT is connected to pull-down resistance, and is a normally non-active terminal.

C. Operation of Ink Cartridge Identifying Device Pertaining to Embodiment 1

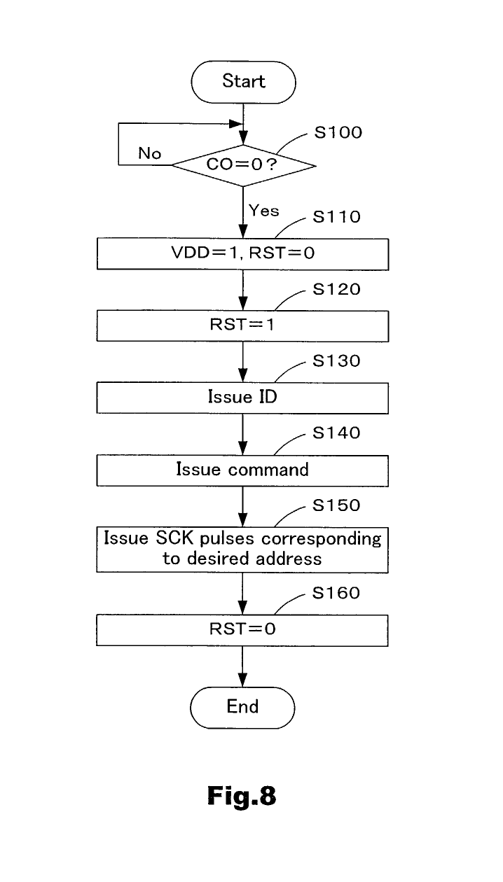

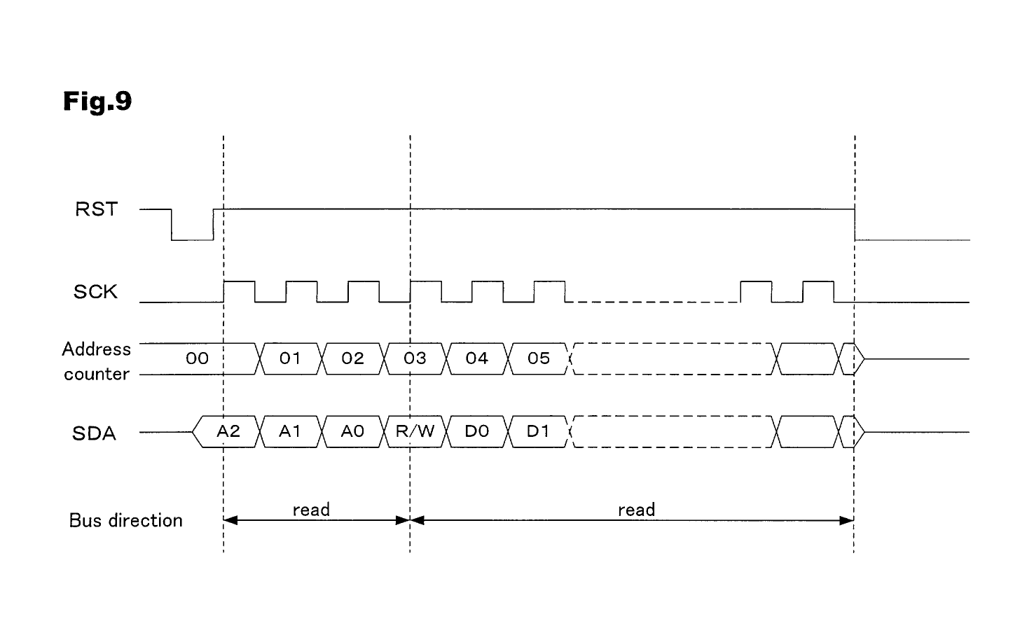

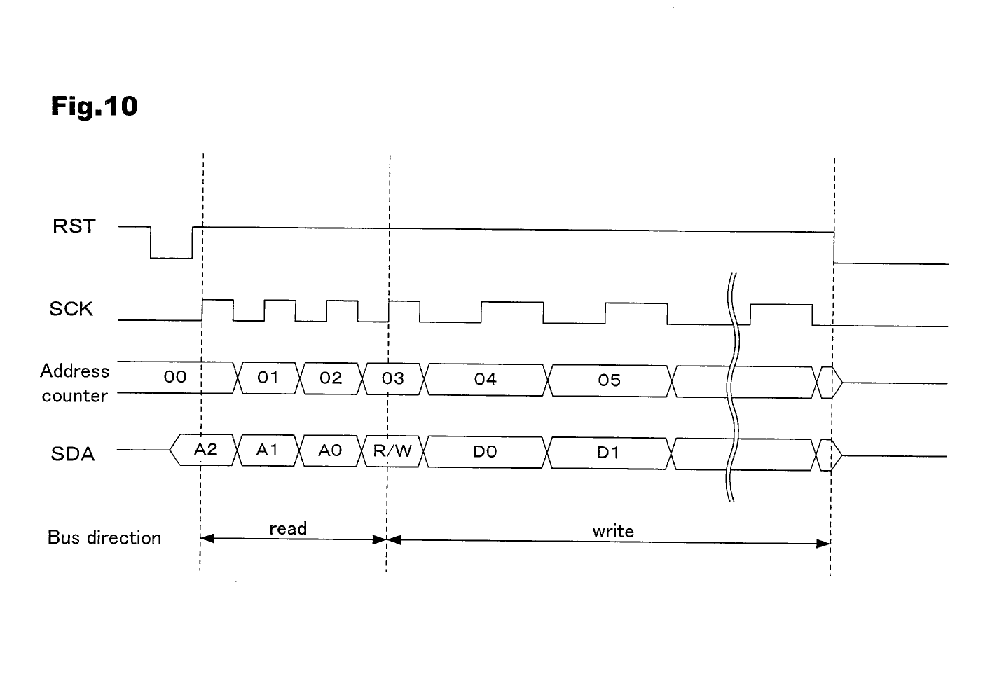

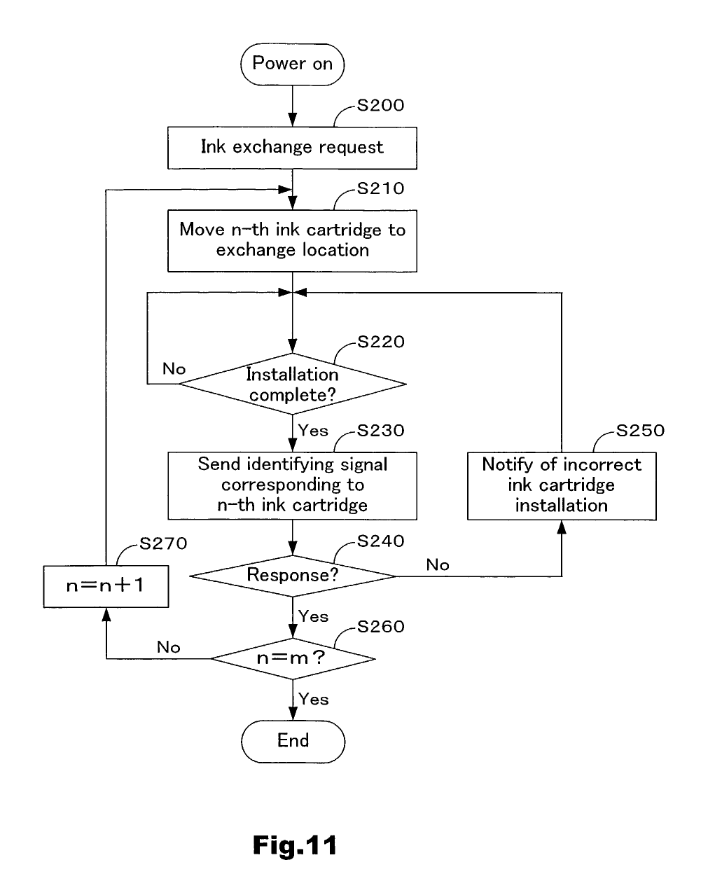

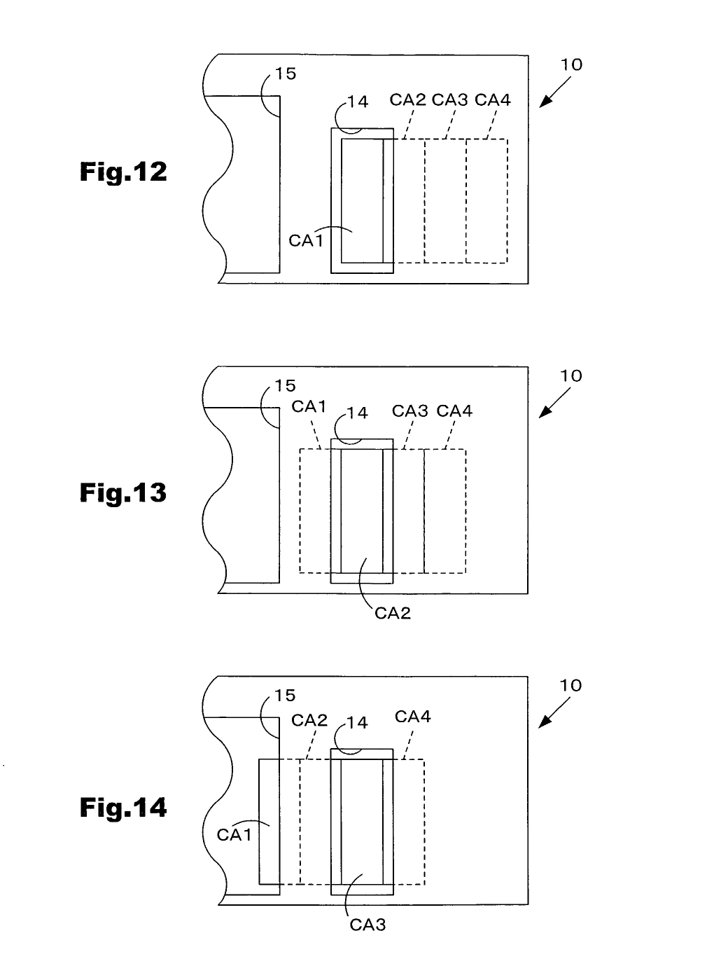

Operation of an ink cartridge identifying device pertaining to Embodiment 1 is described referring to FIG. 8-FIG. 14. FIG. 8 is a flow chart showing a typical processing routine executed by a personal computer PC when accessing memory devices 20, 21, 22, 23 of ink cartridges CA1-CA4. FIG. 9 is a timing chart showing temporal relationships of the reset signal RST, clock signal SCK, data signal CDA, and address counter value when reading data. FIG. 10 is a timing chart showing temporal relationships of the reset signal RST, clock signal SCK, data signal CDA, and address counter value when writing data. FIG. 11 is a flow chart showing a processing routine of an ink cartridge identifying process performed during initial ink cartridge installation. FIG. 12-FIG. 14 are explanatory diagrams showing movement of ink cartridges CA1-CA4 during ink cartridge replacement.

Personal computer PC waits until the input value CO of cartridge out signal line COL goes to 0 (Step S100: No). That is, if all of the ink cartridges are properly seated in the ink cartridge holder, since the cartridge out detection line CDL is cascade connected and grounded via the cartridge out detection terminals COT, the input value CO of cartridge out signal line COL will indicate ground voltage (about 0 V, for example). If, on the other hand, even a single ink cartridge is not properly seated in the ink cartridge holder, the cartridge out detection line CDL is not cascade connected and therefore not grounded, so a value corresponding to the circuit voltage of the control circuit appears on the cartridge out signal line COL. In this embodiment, the effects of noise etc. are eliminated through binarization on the basis of a predetermined threshold value. Thus, the input value of the cartridge out signal line COL will assume the value 0 or 1.

Once the input value CO of cartridge out signal line COL goes to 0 (Step S100: Yes), as shown in FIG. 9 and FIG. 10 personal computer PC supplies power supply voltage to the positive power terminals VDDM of memory devices 20, 21, 22, 23 via power supply line VDL (VDD=1), and causes the reset signal generating circuit to generate a reset signal (set RST=0) which is transmitted to the reset bus RB via the reset signal line RL (Step S110). In other words, power supply voltage is not supplied to memory devices 20, 21, 22, 23 unless the ink cartridges are properly seated in the ink cartridge holder. It should be noted that since the reset signal RST is active low, the expression “generate, input a reset signal RST” herein refers to a reset low signal unless indicated otherwise.

As shown in FIG. 9 and FIG. 10, personal computer PC then sets the reset signal generating circuit to RST=1 and sets the reset signal RST to High (Step S120). Personal computer PC then issues identifying data (ID data) for the ink cartridges CA1-CA8 (memory devices 20, 21, 22, 23) to which access is desired (Step S130). The issued ID data is transmitted to data bus DB over data signal line DL, in sync with the rising edge of the clock signal SCK, as shown in FIG. 9 and FIG. 10.

Personal computer PC issues either a read command (Read) or a write command (Write) to the first data signal line DL1 (Step S140). The issued command is transmitted to the data bus DB via data signal line DL. CPU 31, in the case that the issued command is a Write command, slows down the clock signal speed, and in the case that the issued command is a Read command, maintains the clock signal speed.

Personal computer PC issues clock signal pulses corresponding in number to the address (location) of memory array 201 at which reading or writing is desired (Step S150). That is, since memory device 20 in this embodiment is a sequential access type of memory device, it is necessary to issue clock signal pulses corresponding in number to the address at which reading or writing is desired, and to increment the count value in the address counter 202 until the count value corresponds to the selected address. Finally, personal computer PC causes the reset signal generating circuit to generate a reset low signal (set RST=0) that is transmitted to the reset bus RB via reset signal line RL, terminating access of memory devices 20, 21, 22, 23. Since access is terminated by transmitting a reset signal RST (reset low signal) in this way, and since a reset signal RST is transmitted also in the event of a power interruption during data writing, the data write operation is able to terminate normally, at least for data that has finished writing.

Next, an ink cartridge identifying process performed at initial installation of ink cartridges is described referring to FIG. 11-FIG. 14. When the power is turned on, personal computer PC receives an ink exchange request (Step S200). An ink exchange request is generated automatically in the case that the power is turned on with ink cartridges CA1-CA4 not installed, or in the case that initial loading of an ink cartridge CA has been indicated via the user interface of a driver application shown on a display connected to personal computer PC. It is also generated in the case that an ink cartridge exchange switch SW2 on control panel 13 has been operated.

Personal computer PC moves the n-th ink cartridge to the exchange location via control circuit 30 (Step S210). Personal computer PC is assumed to use “1” as the initial value of n, and in the following explanation is explained as n=1. Accordingly, as shown in FIG. 12, first, the first ink cartridge CA1 is moved to a location corresponding to exchange opening 14. Here, the location at which the exchange opening 14 is formed and the movement distance of each ink cartridge CA are each set to the travel distance of carriage 101 from the home position. Therefore, when an ink cartridge CA is moved to a predetermined location, carriage 101 should be moved a distance set with reference to each ink cartridge CA. The movement distance of carriage 101 can be measured (detected) accurately using a linear encoder or the like. As for ink cartridges CA2, CA3, CA4 as well, as shown in FIG. 13 and FIG. 14, they are moved serially to the location corresponding to exchange opening 14. To facilitate the explanation, only the cases of ink cartridges CA2, CA3 are shown.,

Personal computer PC waits until ink cartridge CA1 is installed on the basis of cartridge out signal COO as described earlier (Step S220: No). When ink cartridge CA1 is installed (Step S220: Yes), identifying data corresponding to identifying data held by memory device 20 of ink cartridge CA1 is transmitted over data bus DB (Step S230).

Personal computer PC determines whether or not there is a response to the transmitted identifying data (Step S240). That is, when the ink cartridge CA1 to be installed is installed, the memory device 20 holding the identifying data corresponding to the transmitted identifying data responds, and if an incorrect ink cartridge CA has been installed, none of the memory devices can respond to identifying data corresponding to memory device 20. Personal computer PC, in the event that there is no response (Step S240: No), notifies to the effect that an incorrect ink cartridge CA has been installed (Step S250), returns to Step S220, and again detects installation of the correct ink cartridge CA. Regarding notification of installation of an incorrect ink cartridge CA, a lamp LM arranged on control panel 13 may be flashed, for example. Alternatively, a warning may be displayed via the driver application user interface screen shown on a display of a personal computer connected via control circuit 30.

Personal computer PC, in the event that there is a response (Step S240: Yes), determines whether installation of all ink cartridges CA1-CA4 has been completed, that is, whether n=m (Step S260). As will be understood from the preceding explanation, in this embodiment m=4. In the case that personal computer PC determines that that n does not equal m, (Step S260: No), it increments n (n=n+1) (Step S270). That is, it identifies (monitors) whether installation of the next ink cartridges CA2-CA4 has been done correctly. As shown in FIG. 13 and FIG. 14, ink cartridges CA2-CA4 are moved serially to a location corresponding to exchange opening 14.

In the case that personal computer PC determines that n=m (Step S20: Yes), it determines that installation of all ink cartridges CA1-CA4 has been completed correctly, and terminates the processing routine.

As explained above, according to the ink cartridge identifying device pertaining to Embodiment 1, at the time of installation of ink cartridges CA, identifying data stored in the memory devices 20-23 of each ink cartridge CA1-CA4 is utilized allowing it to be detected whether the correct ink cartridge CA has been installed. Using the result of detection, it is possible to notify to the effect that an incorrect ink cartridge CA has been installed, and to prompt installation of the correct ink cartridge CA. Further, in the event that an incorrect ink cartridge CA has been installed, the ink cartridge CA identifying process is continued until the correct ink cartridge CA is installed, so the correspondence relationships of ink eject heads PN1-PN4 and ink cartridges CA1-CA4 can be properly maintained.

In this embodiment, incorrect installation of ink cartridges CA can be detected without imparting unique features to contour shapes of ink cartridges, so it is possible to use ink cartridges CA having the same shape, and the cost needed in the case of changing to a different contour for each contained ink type can be reduced. Also, the ink cartridge identifying device of this embodiment is provided with an exchange opening 14 and can limit the installation location of ink cartridges CA, so the correct ink cartridge Ca can be installed at the correct location.

D. Ink Cartridge Identifying Process Pertaining to Embodiment 2

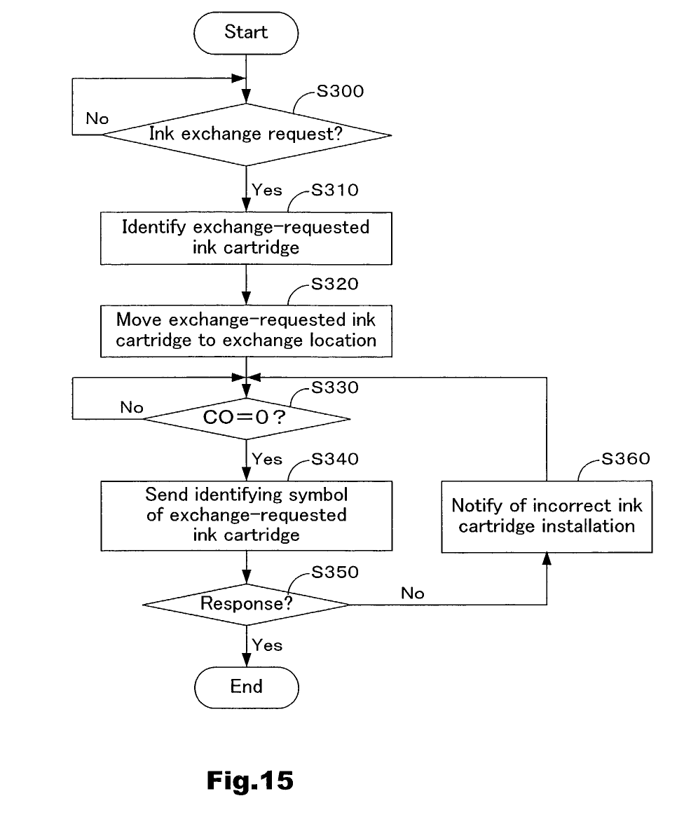

An identifying process of ink cartridges pertaining to Embodiment 2 is described referring to FIG. 15. FIG. 15 is a flow chart showing a processing routine performed during an ink cartridge identifying process pertaining to Embodiment 2. The ink cartridge identifying process pertaining to Embodiment 2 can be executed on the identifying device of ink cartridges pertaining to Embodiment 1.

This processing routine is executed after completing initial installation ink cartridges CA1-CA4, when an ink cartridge CA is empty, etc. Accordingly, personal computer PC waits until an ink exchange request is generated (Step S300: No). An ink exchange request is issued (generated), for example, in the case of the control circuit 30 of color printer 10 monitoring the remaining ink amount in each ink cartridge CA1-CA4, and the remaining ink amount in each ink cartridge CA1-CA4 falls below a predetermined value. Or, it is issued in the case the exchange of a desired ink cartridge is indicated deliberately by the user via the user interface of a driver application displayed on the display connected to personal computer PC. Or, it is generated by the user operating ink cartridge exchange switch SW2.

Personal computer PC, in the event of determining that an ink exchange request has been generated (Step S300: Yes) identifies the ink cartridge CA whose exchange was requested (Step S310). In the case that the ink exchange request was generated by control circuit 30, the ink cartridge CA targeted for exchange is already known (has been identified) to personal computer PC. In the event that the ink exchange request was generated deliberately by the user via the user interface of a driver application, it is identified by acquiring indication information input via the user interface. In the following explanation, for convenience in explanation, it is assumed that an exchange request of ink cartridge CA1 was generated.

Personal computer PC moves the ink cartridge CA1 whose exchange was requested to exchange opening 14 (Step S320). It waits for installation of a new ink cartridge CA1 (Step S330: No). That is, it waits until detecting CO=0 after detecting CO=1. When personal computer PC detects that CO=0 (Step S330: Yes) it transmits over data bus DB identifying data corresponding to the previously identified ink cartridge CA1 (Step S340).

In the event that personal computer PC detects a response from memory device 20 provided to ink cartridge CA1 (Step S350: Yes), it determines that a new ink cartridge CA1 has been correctly installed, and terminates this processing routine. On the other hand, the event that personal computer PC did not detect a response from memory device 20 provided to ink cartridge CA1 (Step S350: No), it determines that a new ink cartridge CA1 has not been correctly installed, and notifies to the effect that an incorrect ink cartridge CA was installed (Step S360), and again checks installation of the correct ink cartridge CA1 (Step S340-Step S360). Notification of an incorrect ink cartridge CA is performed on the basis of the mode described in Embodiment 1.

As explained above, according to the identifying device of ink cartridges pertaining to Embodiment 2, during exchange of ink cartridges CA, identifying data stored in the memory devices 20-23 of each ink cartridge CA1-CA4 is utilized allowing it to be detected whether the correct ink cartridge CA has been installed. Using the result of detection, it is possible to notify to the effect that an incorrect ink cartridge CA has been installed, and to prompt installation of the correct ink cartridge CA. Further, in the event that an incorrect ink cartridge CA has been installed, the ink cartridge CA identifying process is continued until the correct ink cartridge CA is installed, and the aspiration process of ink in ink cartridge CA is not performed, so that soiling of ink eject heads PN1-PN4 due to aspiration of the incorrect ink can be prevented.

In this embodiment, incorrect installation of ink cartridges CA can be detected without imparting unique features to contour shapes of ink cartridges, so it is possible to use ink cartridges CA having the same shape, there is no need to change to a different contour for each contained ink type, and the cost associated with changing contours can be reduced. Also, the ink cartridge identifying device of this embodiment is provided with an exchange opening 14, and can restrict the installation location of ink cartridges CA as well as restricting the installation location of ink cartridges CA, so the ink cartridge CA to be exchanged can be corrected detached/attached.

E. Ink Cartridge Identifying Process Pertaining to Embodiment 3

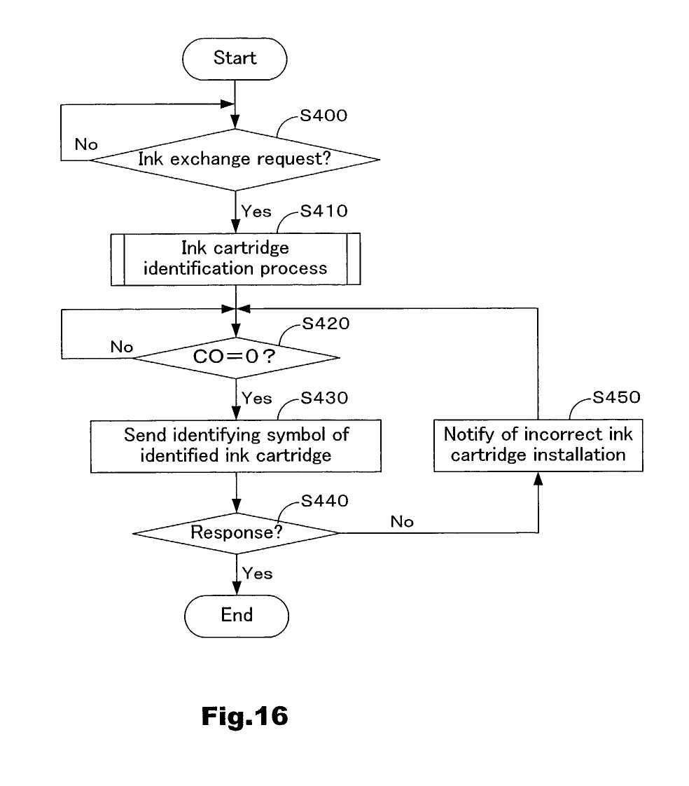

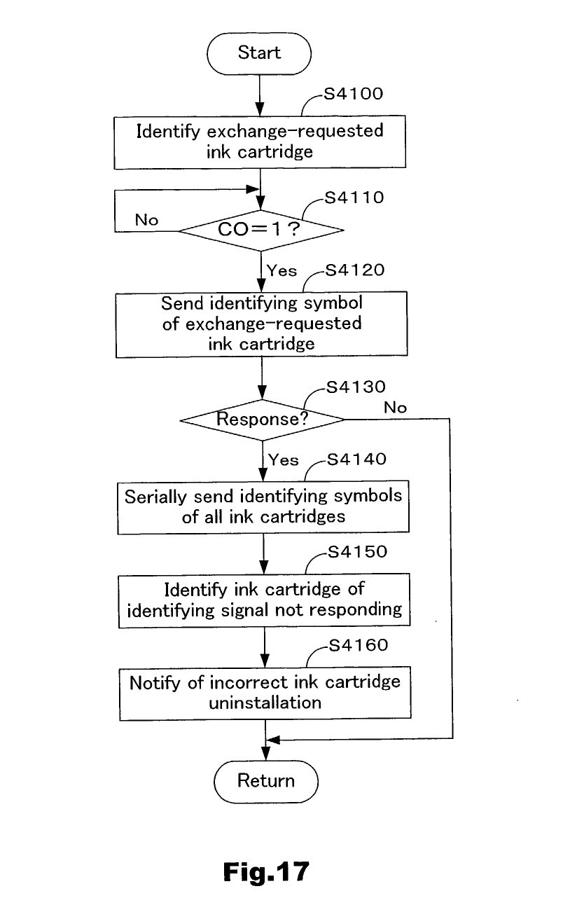

An identifying process of ink cartridges pertaining to Embodiment 3 is described referring to FIG. 16 and FIG. 17. FIG. 16 is a flow chart showing a processing routine performed during an ink cartridge identifying process pertaining to Embodiment 3. FIG. 17 is a flow chart showing a processing routine performed during an ink cartridge identifying process in FIG. 16. Here, the identifying process of ink cartridges pertaining to Embodiment 3 is suitable for a printer not furnished with an exchange opening 14, and permitting the user to arbitrarily detach/attach ink cartridges CA. The identifying process of ink cartridges pertaining to Embodiment 3, while not requiring an exchange opening 14 and movement of ink cartridges CA whose exchange is targeted, is implementable with respect to the identifying device of ink cartridges pertaining to Embodiment 1, so in the following explanation symbols that are the same as symbols used in the identifying device of ink cartridges pertaining to Embodiment 1 are used. However, moving of ink cartridges CA whose exchange is targeted is not performed, and it is assumed that ink cartridges CA are arbitrarily detachable/attachable.

The identifying process of ink cartridges pertaining to Embodiment 3 is executed after completing initial installation ink cartridges CA1-CA4, when an ink cartridge CA is empty, etc. Accordingly, personal computer PC waits until an ink exchange request is generated (Step S400: No). An ink exchange request is generated, for example, by the control circuit 30 which monitors the remaining ink amount in each ink cartridge CA1-CA4, in the case that the remaining ink amount in each ink cartridge CA1-CA4 falls below a predetermined value, or in the case the exchange of a desired ink cartridge CA is indicated deliberately by the user via the user interface of a driver application displayed on the display connected to personal computer PC. Or, it is generated by operation of an ink cartridge exchange switch SW2 provided on color printer 10.

Personal computer PC, in the event of determining that an ink exchange request has been generated (Step S400: Yes) performs an ink cartridge identifying process (Step S410). In this embodiment, since the user can detach/attach arbitrary ink cartridges CA, there is required an ink cartridge identifying process that identifies whether an uninstalled ink cartridge CA is the same as the ink cartridge CA whose exchange was requested. This ink cartridge identifying process is described in detail referring to FIG. 17.

Personal computer PC first identifies the ink cartridge CA whose exchange was requested (Step S4100). In the case that the ink exchange request was generated by control circuit 30, the personal computer PC has already identified the ink cartridge CA targeted for exchange. In the event that the ink exchange request was generated deliberately by the user, the personal computer PC identifies the ink cartridge CA to be exchanged by acquiring indication information of the ink cartridge CA indicated by the user on the user interface. In the following explanation, for convenience in explanation, it is assumed that an exchange request of ink cartridge CA1 was generated.

Personal computer PC waits until the input value CO of cartridge out signal COO becomes 1, that is, until ink cartridge CA is uninstalled (Step S4110: No). In this case, personal computer PC cannot identify which ink cartridge CA has been uninstalled, and waits for uninstallation of any ink cartridge CA. When personal computer PC detects that the input value CO of cartridge out signal COO equals 1 (Step S4110: Yes), it transmits over data bus DB identifying data corresponding to the previously identified ink cartridge CA1 (Step S4120).

Personal computer PC determines whether there is a response to identifying data transmitted over the data bus DB (Step S4130). As mentioned earlier, the memory devices 20-23 of the ink cartridges CA1-CA4 do not respond as long as they do not receive identifying data matching the identifying data held by themselves, and so by transmitting identifying data over the data bus DB it can be detected whether the ink cartridge CA1 whose exchange was requested has been correctly uninstalled. In the event that personal computer PC does not detect a response from memory device 20 provided to ink cartridge CA1 (Step S4130: No), it determines that ink cartridge CA1 whose exchange was requested has been correctly uninstalled, and returns to the processing routine of FIG. 16. That is, by means of the aforementioned process, it is identified that the ink cartridge CA1 whose exchange was requested and the uninstalled ink cartridge CA are the same type of ink cartridge. Then, in the processing routine shown in FIG. 15, it is determined whether the installed ink cartridge CA and ink cartridge CA1 are the same type of ink cartridge.

On the other hand, in the event that personal computer PC does detect a response from memory device 20 provided to ink cartridge CA1 (Step S4130: Yes), it serially transmits over data bus DB identifying data corresponding to identifying data held by all of the memory devices 20-23 (Step S4140). In this case, it is because an ink cartridge CA other than ink cartridge CA1 has been uninstalled, and it is necessary to identify which ink cartridge CA has been uninstalled.

Personal computer PC, of the identifying data serially transmitted over data bus DB, identifies the ink cartridge CA equipped with the memory device corresponding to the identifying data to which there was no response, and temporarily stores it in RAM, not shown, as information of the actually uninstalled ink cartridge CA (Step S1450). Personal computer PC notifies to the effect that an incorrect ink cartridge CA has been uninstalled (Step S4160), and returns to the processing routine of FIG. 16. By means of the above process, the ink cartridge CA actually uninstalled instead of the ink cartridge CA1 whose exchange was requested can be identified. By performing this ink cartridge identifying process, it can be determined whether an uninstalled ink cartridge CA and an installed ink cartridge CA are the same type of ink cartridge. This is because where there is a possibility that an ink cartridge CA other than the ink cartridge CA1 whose exchange was requested could be uninstalled, if the ink cartridge identifying process described above is not performed, it cannot be verified whether an ink cartridge CA whose exchange was requested and an uninstalled ink cartridge CA are the same type.

Returning to FIG. 16 to continue the explanation, personal computer PC waits until detecting installation of a new ink cartridge CA1, that is, until detecting CO=0 (Step S420: No). When personal computer PC detects that CO=0 (Step S420: Yes) it transmits over data bus DB identifying data corresponding to the ink cartridge CA identified in the ink cartridge identifying process (Step S430).

In the event that personal computer PC detects a response from the memory device (or memory device 20) provided to the identified ink cartridge CA (or ink cartridge CA1), (Step S440: Yes), it determines that a new ink cartridge CA has been correctly installed, and terminates this processing routine. On the other hand, the event that personal computer PC did not detect a response from the memory device provided to the identified ink cartridge CA (Step S440: No), it determines that an ink cartridge CA of the same type as the previously uninstalled ink cartridge CA has not been installed, notifies to the effect that an incorrect ink cartridge CA was installed (Step S450), and again checks installation of the correct ink cartridge CA (Step S410-Step S440). Notification of an incorrect ink cartridge CA is performed on the basis of the mode described in Embodiment 1.

As explained above, according to the identifying device of ink cartridges pertaining to Embodiment 3, during exchange of ink cartridges CA, identifying data stored in the memory devices 20-23 of each ink cartridge CA1-CA4 is utilized, allowing it to be detected whether the correct ink cartridge CA has been installed. Also, in this embodiment, it can be identified whether an uninstalled ink cartridge CA is the ink cartridge CA that should have been uninstalled, so even in cases where the printer lacks a physically restricting structure, for example, being provided with an exchange opening 14, wherein the ink cartridge CA to be exchanged is moved to the exchange opening 14, it can be identified accurately whether an uninstalled ink cartridge CA and an installed ink cartridge CA match. The identifying process of ink cartridges pertaining to Embodiment 3 is of course applicable to printers provided with a physically restricting structure such as an exchange opening 14. In this case, even if an ink cartridge CA has been uninstalled without going through the normal procedure, it can be identified more reliably whether an uninstalled ink cartridge CA is the ink cartridge CA that should have been uninstalled.

Using the result of detection, it is possible to notify to the effect that an incorrect ink cartridge CA has been installed, and to prompt installation of the correct ink cartridge CA, via the user interface on the display screen of the personal computer PC, or via an indicator lamp LM on color printer 10. Further, in the event that an incorrect ink cartridge CA has been installed, the ink cartridge CA identifying process is continued until the correct ink cartridge CA is installed, and the aspiration process of ink in ink cartridge CA is not performed, so that soiling of ink eject heads PN1-PN4 due to aspiration of the incorrect ink can be prevented.

In this embodiment, incorrect installation of ink cartridges CA can be detected without imparting unique features to contour shapes of ink cartridges, so it is possible to use ink cartridges CA of the same shape, there is no need to change to a different contour for each contained ink type, and the cost associated with changing contours can be reduced.

F. Ink Cartridge Identifying Device Pertaining to Embodiment 4

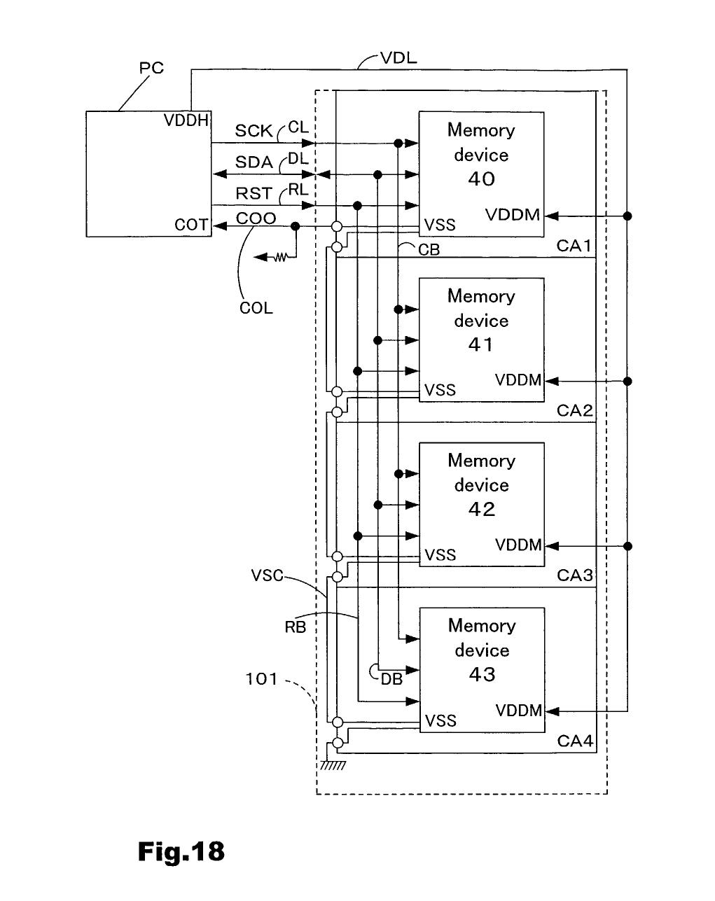

The ink cartridge identifying device pertaining to Embodiment 4 is described with reference to FIG. 18. FIG. 18 is a block diagram showing interconnects of the control circuit and memory devices used in the ink cartridge identifying device pertaining to Embodiment 4. The ink cartridge identifying device pertaining to Embodiment 4, apart from some differences in interconnections of memory devices and the control circuit, basically has the same arrangement as the ink cartridge identifying device pertaining to Embodiment 1, and so the same symbols are assigned to the same constituent elements, and description thereof is omitted.

The data signal terminals DT, clock signal terminals CT and reset signal terminals RT of the memory devices 40, 41, 42, 43 in this embodiment are respectively connected via a data bus DB, clock bus CB and reset bus RB. Personal computer PC and data bus DB, clock bus CB, and reset bus RB are connected via a data signal line DL, clock signal line CL, and reset signal line RL. These signal lines are realized as flexible feed cable (FFC), for example. The positive power terminal VDDH of CPU 31 and the positive power terminals VDDM of memory devices 40, 41, 42, 43 are connected via a power supply line VDL. The negative power terminals VSS of memory devices 40, 41, 42, 43 are connected in cascade to a negative power line VSL on carriage 101. A first end of negative power line VSL is grounded, while the other end is connected via a cartridge out signal line COL to the cartridge out detection terminal COT of personal computer PC.

In the ink cartridge identifying device pertaining to Embodiment 4, since the negative power line VSL is used also as a cartridge out detection line, arrangement of signal lines with respect to memory devices 40, 41, 42, 43 can be made easy. Also, apart from during initial installation of ink cartridges, it can be reliably identified whether the correct ink cartridge CA has been installed, without devising any other special means.

G. Ink Cartridge Identification Replacement Process Pertaining to Embodiment 5

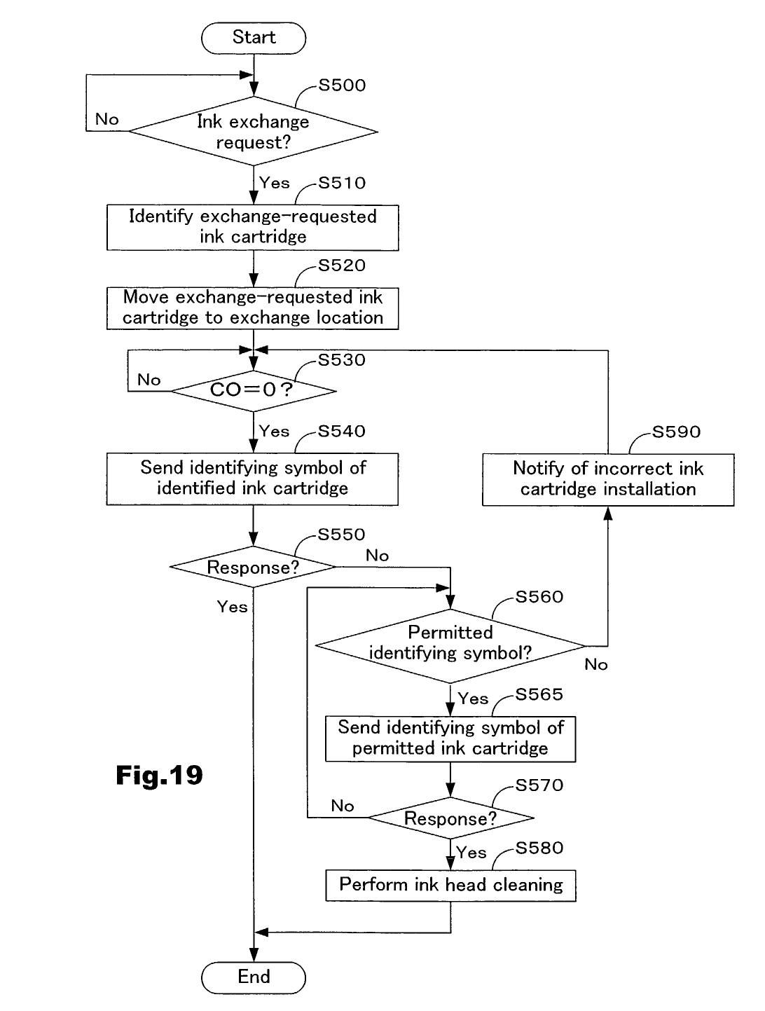

Next, the ink cartridge identification exchange process pertaining to Embodiment 5 is described with reference to FIG. 19. FIG. 19 is a flow chart showing a processing routine performed during an ink cartridge identification exchange process pertaining to Embodiment 5. The ink cartridge identification exchange process pertaining to Embodiment 5 may be implemented on the ink cartridge identifying device pertaining to Embodiment 1.

This processing routine is executed after completing initial installation ink cartridges CA1-CA4, when ink contained in an ink cartridge CA is empty, etc. Accordingly, personal computer PC waits until an ink exchange request is generated (Step S500: No). An ink exchange request is issued (generated), for example, in the case that the control circuit 30 of color printer 10 monitors the remaining ink amount in each ink cartridge CA1-CA4, and the remaining ink amount in each ink cartridge CA1-CA4 falls below a predetermined value. Alternatively, it is issued in the case the exchange of a desired ink cartridge is indicated deliberately by the user via the user interface of a driver application displayed on the display connected to personal computer PC. Or, it is generated by the user operating ink cartridge exchange switch SW2.

Personal computer PC, in the event of determining that an ink exchange request has been generated (Step S500: Yes) identifies the ink cartridge CA whose exchange was requested (Step S510). In the case that the ink exchange request was generated by control circuit 30, the ink cartridge CA targeted for exchange is already known (has been identified) to personal computer PC. In the event that the ink exchange request was generated deliberately by the user via the user interface of a driver application, it is identified by acquiring indication information input via the user interface. In the following explanation, for convenience in explanation, it is assumed that an exchange request of ink cartridge CA1 was generated.

Personal computer PC moves the ink cartridge CA1 whose exchange was requested to exchange opening 14 (Step S520), and waits for installation of a new ink cartridge CA1 (Step S530: No). That is, it waits until detecting CO=0 after detecting CO=1. When personal computer PC detects that CO=0 (Step S530: Yes) it transmits over data bus DB identifying data (identifier symbol) corresponding to the previously identified ink cartridge CA1 (Step S540).

In the event that personal computer PC detects a response from memory device 20 provided to ink cartridge CA1 (Step S550: Yes), it determines that a new ink cartridge CA1 has been correctly installed, and terminates this processing routine. On the other hand, the event that personal computer PC did not detect a response from memory device 20 provided to ink cartridge CA1 (Step S550: No), it determines whether there exists an ink cartridge CA* interchangeable with ink cartridge CA1, that is, whether there is exists an identifier symbol whose use is permitted in place of identifying data corresponding to ink cartridge CA1 (Step S560).

This determination is a determination required to permit changing ink type, for example, in the case of installing an ink cartridge CA* containing dark yellow ink in place of ink cartridge CA1 containing black ink, installing light magenta and light cyan instead of magenta and cyan, respectively. Permitted identifier symbols are stored in ROM (not shown) in personal computer PC or in PROM 32 in printer 10.

In the event that personal computer PC determines that a permitted identifier symbol exists (Step S560: Yes), it sends the permitted identifier symbol over data bus DB (Step S565). Personal computer PC, in the event of detecting a response from the memory device provided to ink cartridge CA* installed in place of ink cartridge CA1 (Step S570: Yes), determines that a new ink cartridge CA* has been correctly installed.

Personal computer PC performs a cleaning process of ink eject head PN1 via the control circuit 30 of printer 10 (Step S580), and terminates this routine. Since the ink type (ink color) contained differs between ink cartridge CA1 and ink cartridge CA*, ink drops of ink cartridge CA1 remaining in ink eject head PN1 are expelled (cleaned) to prevent ink of ink cartridge CA1 from mixing with ink of ink cartridge CA*. Cleaning is performed, for example, by means of performing forcible expulsion of ink drops typically performed prior to aspiration of ink from the new ink cartridge CA*, and then performing aspiration of the ink of the new ink cartridge CA* and forcible expulsion again, to replace ink drops in the ink eject head PN1 with ink of the new ink cartridge CA*.

If on the other hand personal computer PC did not detect a response from memory device 20 provided to ink cartridge CA1 (Step S570: No), it again determines whether there exists another ink cartridge CA* interchangeable with ink cartridge CA1 (Step S560). That is, in response to cases where there exist a multiplicity of ink cartridges CA* interchangeable with ink cartridge CA1, is sequentially uses identifier symbols for candidate ink cartridges CA*.

In the event that personal computer PC determines that a permissible identifier symbol exists (Step S560: Yes), it executes Step S565- Step S580 described previously. On the other hand, in the event that personal computer PC determines that a permissible identifier symbol does not exist (Step S560: No), it determines that a new ink cartridge CA1 or ink cartridge CA* was not correctly installed, notifies to the effect that an incorrect ink cartridge CA was installed (Step S590), waits until installation of the correct ink cartridge CA1, CA* is completed (Step S340-Step S360). Notification of an incorrect ink cartridge CA is performed on the basis of the mode described in Embodiment 1.

As explained above, according to the identifying device of ink cartridges pertaining to Embodiment 5, even if there exists an ink cartridge CA* interchangeable with a certain ink cartridge CA, it can be detected whether the correct ink cartridge CA has been installed. Where an ink cartridge CA is exchanged with an ink cartridge CA containing the ink type (ink color) prior to exchange, a cleaning process of ink eject head PN is performed, so mixing of ink prior to exchange with ink after exchange can be prevented. Thus, even if ink color is exchanged, the correct ink can be ejected and correct image output can be obtained.

Additionally, since exchange of ink cartridges CA is permitted, when, for example, printing text, by using a multiplicity of ink cartridges CA of black ink, or when printing images, by using image printing-use light ink, printing may be accomplished by an ink cartridge arrangement suitable to the printing purpose.

According to Embodiment 5, additionally, various advantages obtainable by means of Embodiment 2 can be obtained analogously.

H. Other Embodiments

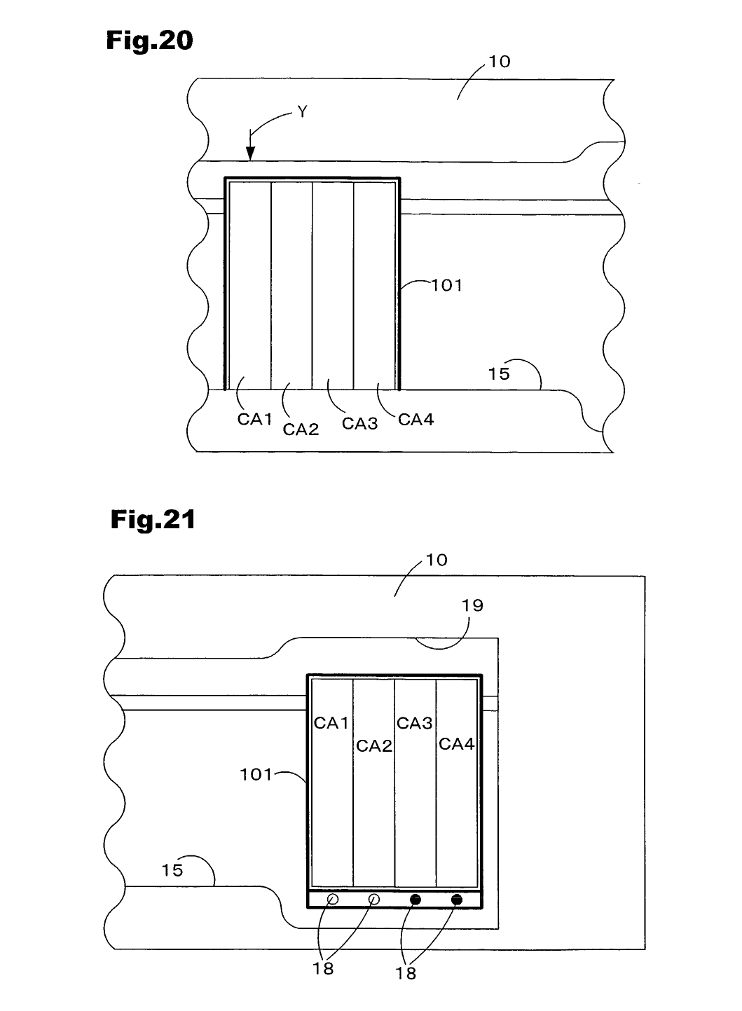

In the above embodiments, color printer 10 is provided with an ink cartridge exchange-use exchange opening 14 that permits detachment/attachment of only one ink cartridge CA, and there is provided an arrangement whereby the ink cartridge CA to be replaced is indicated, and the ink cartridge CA to be replaced is correctly uninstalled. In contrast to this, it is acceptable to not provide an exchange opening 14, to use a typical opening portion that permits detachment/attachment of a multiplicity of ink cartridges CA, and to indicate the ink cartridge CA to be replaced, in the manner shown in FIG. 20 and FIG. 21. FIG. 20 is an explanatory diagram showing the maintenance opening 15 of a color printer 10 with a Y indicating the ink cartridge CA to be replaced. FIG. 21 is an explanatory diagram showing a carriage 101′ comprising an LED that indicates the ink cartridge CA to be replaced.

In the embodiment shown in FIG. 20, control circuit 30, by driving carriage motor 103, and moving the ink cartridge CA to be replaced to the position of arrow Y provided to maintenance opening 15, indicates to the user the ink cartridge CA to be replaced. Thus, without providing a special exchange opening 14 to printer 10, the ink cartridge CA to be replaced can be pointed out the use by means of arrow Y, so that exchange of the correct ink cartridge CA can be achieved. In the event that a multiplicity of ink cartridges CA are to be replaced, it can be achieved by repeating multiple times the process of moving the ink cartridge to be exchanged to the location of arrow Y. Also, an arrow Y may be provided at the ink exchange location 19, to point out at the ink exchange location the ink cartridge to be exchanged.

In the embodiment shown in FIG. 21, LEDs 18 are provided on carriage 101 in a number corresponding to the ink cartridges CA mounted thereon. During ink cartridge CA exchange, control circuit 30, after moving carriage 101 to the ink exchange location 19, lights or extinguishes the LED 18 corresponding to the ink cartridge to be exchanged, to point out to the user the ink cartridge to be exchanged. Where there exists a multiplicity of ink cartridges to be exchanged, multiple LEDs 18 are lit simultaneously. Ink exchange location 19 is a typical opening allowing a multiplicity of ink cartridges CA to be detached/attached. Accordingly, when exchanging an ink cartridge CA, the ink cartridge CA to be exchanged can be identified (pointed out) without moving the carriage 101 multiple times, and without any need for the user to memorize the ink cartridge CA to be exchanged, the correct ink cartridge CA can be exchanged more easily. Also, LEDs 18 may be provided to the opening of ink exchange location 19, rather than on carriage 101. Of course it is not limited to LEDs, it being possible to use various lights including incandescent.

Hereinabove, there were explained on the basis of several embodiments identifying devices of printer recording material receptacles (ink cartridges) pertaining to the present invention, but the embodiments of the invention described above are intended to facilitate understanding of the invention and do not limit the invention. The invention can be modified or improved without departing from the scope and spirit thereof as set forth in the claims, and these equivalents are of course included in the invention.

In the preceding embodiments, there were described ink cartridge identifying devices that without using a chip select signal, identify desired ink cartridges CA using only identifying data stored in memory devices 20-23, 40-43 provided to the ink cartridges CA, but the invention is applicable also in the case of selection of ink cartridges CA using a chip select signal. In this case, to identify each memory device, a chip select signal line is arranged between the control circuit and the memory devices. It is possible that the control circuit identify by means of a chip select signal the memory device to which access is desired, and prior to access transmit the chip select signal to the desired memory device. Since the chip select signal line and installation locations of the ink cartridges CA are associated, the control circuit possesses in advance location information of the ink cartridges (memory devices), and using this location information can identify whether or not correct ink cartridges have been installed at the individual ink cartridge installation locations, even when a multiplicity of ink cartridges are detached/attached all at once. It should be noted that, in this case as well, identifying data stored in each memory device would be used to determine which ink type is contained in the ink cartridge.

In the preceding embodiments, the ink cartridge CA identifying process is executed by means of a personal computer PC, but this series of processes could instated by performed by control circuit 30 of color printer 20. In this case, the ink cartridge CA identifying process can be performed by color printer 20 alone. Where the ink cartridge CA identifying process is performed by color printer 20 only, notification made during installation of an incorrect ink cartridge CA etc. is achieved via a lamp LM or display provided to color printer 20.

In the preceding embodiments, the use of EEPROM as memory devices 20-23, 40-43 is described, but memory devices are not limited to EEPROM, provided that they can hold data in nonvolatile fashion, and allow rewriting of stored data. For example, ferroelectric memory, battery backup type memory, etc. is acceptable.

In the preceding embodiments, identifying data is stored on the leading 3 bits of memory array 201, but the volume of identifying data can be modified as appropriate to the number of storage devices needing to be identified. Memory array 201 capacity is not limited to 256 bits, and may be modified as appropriate to the amount of data needing to be stored.

In the preceding embodiments, the four memory devices 20, 21, 22, 23 are described as being provided on independent ink cartridges of four colors (four), but instead the memory device 20 pertaining to the embodiments could be implemented in ink cartridges of 2 to 3 colors, or 5 or more colors.

In the preceding embodiments, the print recording material receptacle identifying device pertaining to the invention is described using ink jet printer-use ink cartridges CA1-CA4, but it goes without saying that besides ink cartridges CA1-CA4, toner cartridges etc. could be used.

In the preceding embodiments, during notification of installation of an incorrect ink cartridge CA, there is given the example of the user interface of a driver application or an indicator lamp LM, but notification by sound via personal computer PC, or notification via a display provided to color printer 10 are possible as well. Also, the body of color printer 10 can be provided with a sound synthesis circuit and a speaker, and installation of an incorrect ink cartridge CA notified by sound by color printer 10 independently.

In the preceding embodiments, there was described using ink cartridges CA of the same shape, but it is also effective with ink cartridges CA of different shapes. For example, when using an ink cartridge containing black ink and an integrated ink cartridge containing a multiplicity of color inks, the installation portion of a typical color ink cartridge is larger than the installation portion of the black cartridge, and in some cases has a structure that permits installation of a black cartridge. However, if a black cartridge is installed in the installation portion of a color ink cartridge, correct printing processes will no longer be able to be performed. Therefore, even if, for example, ink cartridges have different size or shape, by implementing the present invention, incorrect installation of ink cartridges can be prevented more appropriately.

1. An identifying device of a printer recording material receptacle having a memory device that stores identifying information and that is also installed in a printing device, said identifying device comprising:
determining means that uses identifying information stored in said memory device to determine whether said installed printer recording material receptacle is the correct printer recording material receptacle to be installed.

2. An identifying device of a printer recording material receptacle according to claim 1 further comprising:
notification means notifying to the effect that an incorrect printer recording material receptacle was installed, in the event of determination by said determining means that said installed printer recording material receptacle is not the correct printer recording material receptacle to be installed.

3. An identifying device of a printer recording material receptacle according to claim 1 or 2 further comprising:
aspiration disabling means that disables aspiration of the printer recording material in a printer recording material receptacle until it has been determined by said determining means that said installed printer recording material receptacle is the correct printer recording material receptacle to be installed.

4. An identifying device of a printer recording material receptacle according to any of claims 1 to 3 wherein the identifying device is characterized in that
in said printing device a multiplicity of printer recording material receptacles are respectively installed at predetermined installation locations, and
said determining means, on the basis of identifying information of a memory device having installation location information relating a printer recording material receptacle to be installed at each said installation location and said installation location, and installed in said installed printer recording material receptacle and said installation location information, determines whether said installed printer recording material receptacle is the correct printer recording material receptacle to be installed.

5. An identifying device of a printer recording material receptacle according to any of claims 1 to 3 wherein the identifying device is characterized in that
said determining means,
using identifying information stored in said memory device, in the event that uninstallation of said printer recording material receptacle is detected, identifies said uninstalled printer recording material receptacle, and in the event that installation of said printer recording material receptacle is detected, uses identifying information of said installed printer recording material receptacle to determine whether said installed printer recording material receptacle is a printer recording material receptacle containing printer recording material identical to or interchangeable with said uninstalled printer recording material receptacle.

6. An identifying device of a printer recording material receptacle according to any of claims 1 to 3 wherein the identifying device is characterized in that
said determining means,
using identifying information stored in said memory device, in the event that uninstallation of said printer recording material receptacle is detected, identifies said uninstalled printer recording material receptacle, and in the event that installation of said printer recording material receptacle is detected, identifies said installed printer recording material receptacle, and on the basis of that designation result, determines whether said installed printer recording material receptacle is a printer recording material receptacle that contains a printer recording material identical to said uninstalled printer recording material receptacle.

7. An identifying device of a printer recording material receptacle according to claim 6 wherein the identifying device is characterized in that
a multiplicity of printer recording material receptacles are installed in said printing device;
memory devices provided to said multiplicity of printer recording material receptacles respond only in the event of having received an identifying signal corresponding to stored identifying information, and
said determining means, after detecting uninstallation of said printer recording material receptacle, transmits to each said memory device an identifying signal corresponding to all identifying information, and identifies the printer recording material receptacle equipped with the unresponsive memory device as the printer recording material receptacle that has been uninstalled, and after installation of said printer recording material receptacle has been detected, transmits to each said memory device an identifying signal corresponding to identifying information stored in said unresponsive memory device, and when a response is obtained, determines that the correct printer recording material receptacle has been installed.

8. An identifying device of a printer recording material receptacle according to any of claims 1 to 7 further comprising:
a memory device detection signal line connected in cascade to each said memory device with one end thereof grounded and the other end thereof connected to memory device detection voltage; and
attachment/detachment detecting means that detects attachment/detachment of a printer recording material receptacle based on the value of said memory device detection signal line.

9. An identification method of a printer recording material receptacle that comprises a memory device storing identifying information corresponding to a type of printer recording material, and that is installed in a printing device, said identification method comprising:
detecting uninstallation of said printer recording material receptacle;
identifying the type of printer recording material of said uninstalled printer recording material receptacle using identifying information stored in said memory device;
detecting installation of said printer recording material receptacle;
identifying the type of printer recording material of said installed printer recording material receptacle using identifying information stored in said memory device; and
determining whether the correct printer recording material receptacle was installed on the basis of the identification result of the type of printer recording material of said installed printer recording material receptacle and the identification result of the type of printer recording material of said uninstalled printer recording material receptacle.

10. An identification method of a printer recording material receptacle according to claim 9 wherein the identification method is characterized in that
in the event that the type of printer recording material of said installed printer recording material receptacle and the type of printer recording material of said uninstalled printer recording material receptacle are identical or of interchangeable type, it is determined that the correct printer recording material receptacle has been installed.

11. An identification method of a printer recording material receptacle according to claim 9 or 10 wherein the identification method is characterized in that
in the event that the type of printer recording material of said installed printer recording material receptacle and the type of printer recording material of said uninstalled printer recording material receptacle are different, it is determined that an incorrect printer recording material receptacle has been installed, and notification is made of installation of an incorrect printer recording material receptacle.

12. An identification method of a printer recording material receptacle according to any of claims 9 to 11 wherein the identification method is characterized in that
aspiration of the printer recording material in said printer recording material receptacle is disabled until it has been determined whether said installed printer recording material receptacle is the correct printer recording material receptacle to be installed.

13. An identification method of a printer recording material receptacle comprising a memory device storing identifying information corresponding to a type of printer recording material and installed at a predetermined location on a printing device with reference to said type of printer recording material, said identification method comprising:
detecting uninstallation of said printer recording material receptacle;
memorizing the installation location at which said uninstalled printer recording material receptacle was installed;
detecting installation of said printer recording material receptacle;
identifying the type of printer recording material of said installed printer recording material receptacle using identifying information stored in said memory device; and
determining whether the correct printer recording material receptacle was installed on the basis of the installation location of said installed printer recording material receptacle and the type of printer recording material of said installed printer recording material receptacle.

14. An identification method of a printer recording material receptacle according to claim 13 wherein the identification method is characterized in that
in the event of a determination that an incorrect printer recording material receptacle was installed, notification is made of installation of an incorrect printer recording material receptacle.

15. A computer-readable medium storing a program monitoring exchange of a printer recording material receptacle that comprises a memory device storing identifying information corresponding to a type of printer recording material, and that is installed at a predetermined location on a printing device with reference to the type of printer recording material, wherein said program executes by means of a computer
a function of detecting uninstallation of said printer recording material receptacle,
a function of memorizing the installation location at which said uninstalled printer recording material receptacle was installed,
a function of detecting installation of said printer recording material receptacle,
a function of identifying the type of printer recording material of said installed printer recording material receptacle using identifying information stored in said memory device, and
a function of determining whether the correct printer recording material receptacle was installed on the basis of the installation location of said installed printer recording material receptacle and the type of printer recording material of said installed printer recording material receptacle,.

16. A printer recording material receptacle exchange control device in a printing device having installed therein a multiplicity of printer recording material receptacles having memory devices storing identifying information corresponding to the type of printer recording material contained therein, said printer recording material receptacle exchange control device comprising:
exchange request detecting means that detects an exchange request of a printer recording material;
printer recording material receptacle moving means that moves the printer recording material receptacle containing the printer recording material whose replacement was requested to a replacement location;
attachment/detachment detecting means that detects uninstallation of said printer recording material receptacle that has been moved to said replacement location, as well as installation of a printer recording material receptacle subsequent to uninstallation; and
determining means that uses said identifying information to determine whether said installed printer recording material receptacle is the correct printer recording material receptacle containing the printer recording material whose replacement was requested.

17. A printer recording material receptacle exchange control device according to claim 16 wherein the exchange control device is characterized in that
said printing device has printing means that prints using said printer recording material, and expelling means that expels said printer recording material held by said printing means,
said correct printer recording material receptacle includes a printer recording material receptacle that contains a printer recording material identical to or interchangeable with said printer recording material whose replacement was requested, and
said exchange control device further comprises
exchange-time expelling means that, in the event of a determination by said determining means that a printer recording material receptacle containing a printer recording material interchangeable with said installed printer recording material has been installed, expels by means of said expelling means the printer recording material held by said printing means.

18. A printer recording material receptacle exchange control device according to claim 16 wherein the printer recording material receptacle exchange control device is characterized in that
said printer recording material receptacle moving means identifies a printer recording material receptacle containing a printer recording material whose replacement was requested using identifying information stored in said memory device and/or installation location information of said printer recording material receptacle.

19. A printer recording material receptacle exchange control device according to claim 16 or 18 wherein the printer recording material receptacle exchange control device is characterized in that
the memory devices provided to said multiplicity of printer recording material receptacles respond only when receiving identifying information that matches stored identifying information, and
said determining means, after uninstallation of a said printer recording material receptacle has been detected, transmits to each said memory device an identifying signal corresponding to all identifying information, and identifies the printer recording material receptacle equipped with the unresponsive memory device as the printer recording material receptacle that has been uninstalled, and after installation of said printer recording material receptacle has been detected, transmits to each said memory device an identifying signal corresponding to identifying information stored in said unresponsive storage, and when a response is obtained, determines that the correct printer recording material receptacle has been installed.

20. A printer recording material receptacle exchange control device according to any of claims 16 to 19 wherein the printer recording material receptacle exchange control device is characterized in that
said printing device comprises in said replacement location an attachment/detachment restricting mechanism that enables attachment/detachment only of a printer recording material receptacle containing a printer recording material receptacle whose replacement was requested.

21. A printer recording material receptacle exchange control device according to claim 20 wherein the printer recording material receptacle exchange control device is characterized in that
said attachment/detachment restricting mechanism is a cover having a replacement opening.

22. A printer recording material receptacle exchange control device according to any of claims 16 to 21 wherein the printer recording material receptacle exchange control device is characterized by further comprising
notifying means that in the event it is determined that said installed printer recording material receptacle is not the correct printer recording material receptacle, notifies to the effect that an incorrect printer recording material receptacle was installed.

23. A printer recording material receptacle exchange control device according to any of claims 16 to 22 wherein the printer recording material receptacle exchange control device is characterized by further comprising
a memory device detection signal line connected in cascade to each said memory device with one end thereof grounded and the other end thereof connected to memory device detection voltage,
wherein said attachment/detachment detecting means detects attachment/detachment of a printer recording material receptacle based on the value of said memory device detection signal line.

24. A printer recording material receptacle exchange control device according to any of claims 16 to 23 wherein the printer recording material receptacle exchange control device is characterized by further comprising
aspiration disabling means that disables aspiration of the printer recording material in a printer recording material receptacle until it has been determined whether said installed printer recording material receptacle is the correct printer recording material receptacle to be installed.

25. A printer recording material receptacle exchange control device in a printing device having installed therein a multiplicity of printer recording material receptacles having memory devices storing identifying information corresponding to the type of printer recording material contained therein, wherein said printer recording material receptacle exchange control device comprising:
exchange request detecting means that detects printer recording material exchange requests;
indicating means that shows the printer recording material receptacle containing the printer recording material whose replacement was requested;
attachment/detachment detecting means that detects uninstallation of said printer recording material receptacle shown by said indicating means and that detects installation of a printer recording material receptacle following uninstallation; and
determining means that uses said identifying information to determine whether said inserted printer recording material receptacle is the correct printer recording material receptacle containing the printer recording material whose replacement was requested.

26. A printer recording material receptacle exchange control device according to claim 25 wherein the printer recording material receptacle exchange control device is characterized in that
said printing device has an exchange location at which said printer recording material receptacle is exchanged, and
said indicating means is arranged at said exchange location in said printing device.

27. A printer recording material receptacle exchange control device according to claim 25 wherein the printer recording material receptacle exchange control device is characterized in that
said printing device has a carriage on which said printer recording material receptacle is mounted, and
said indicating means is arranged at a location corresponding to the mounting location of said printer recording material receptacle in said carriage.

28. A printer recording material receptacle exchange control device according to any of claims 25 to 27 wherein the printer recording material receptacle exchange control device is characterized by further comprising
a memory device detection signal line connected in cascade to each said memory device with one end thereof grounded and the other end thereof connected to memory device detection voltage,
wherein said attachment/detachment detecting means detects attachment/detachment of a printer recording material receptacle based on the value of said memory device detection signal line.

29. A printer recording material receptacle exchange control device according to any of claims 25 to 28 wherein the printer recording material receptacle exchange control device is characterized by further comprising
aspiration disabling means that disables aspiration of the printer recording material in a printer recording material receptacle until it has been determined whether said installed printer recording material receptacle is the correct printer recording material receptacle to be installed.

30. An exchange control method of printer recording material receptacles in a printing device having a multiplicity of printer recording material receptacles installed, said exchange control method comprising:
detecting an exchange request of a printer recording material;
moving the printer recording material receptacle containing said printer recording material whose replacement was requested to an exchange location;
detecting uninstallation of said printer recording material receptacle moved to said replacement location, and detecting installation of a printer recording material receptacle following uninstallation; and
determining whether said installed printer recording material receptacle is the correct printer recording material receptacle containing the printer recording material whose replacement was requested using identifying information corresponding to the type of printer recording material contained in said printer recording material receptacle.

31. An exchange control method of printer recording material receptacles according to claim 30 wherein
said correct printer recording material receptacle includes a printer recording material receptacle containing a printer recording material identical to or interchangeable with said printer recording material whose replacement was requested, and
in the event of a determination that a printer recording material receptacle containing a printer recording material interchangeable with said installed printer recording material has been installed,
additionally, printer recording material held by printing means that performs printing using said printer recording material is expelled.

32. An exchange control method of printer recording material receptacles according to claim 30 wherein
the printer recording material receptacle containing said printer recording material receptacle whose replacement was requested is identified using identifying information stored in said memory device and/or installation location information of said printer recording material receptacle.

33. A computer readable storage medium that stores a program of exchange control of printer recording material receptacles in a printing device having a multiplicity of printer recording material receptacles installed therein, wherein the computer readable storage medium is characterized in that said program executes by means of a computer
a function of detecting an exchange request of a printer recording material,
a function of moving the printer recording material receptacle containing said printer recording material whose replacement was requested to a replacement location,
a function of detecting uninstallation of said printer recording material receptacle moved to said replacement location and detecting installation of a printer recording material receptacle following uninstallation, and
a function of determining whether said installed printer recording material receptacle is the correct printer recording material receptacle containing the printer recording material whose replacement was requested using identifying information corresponding to the type of printer recording material contained in said printer recording material receptacle.

34. A computer readable storage medium according to claim 33 wherein
said correct printer recording material receptacle includes a printer recording material receptacle containing a printer recording material receptacle identical to or interchangeable with said printer recording material whose replacement was requested, and
in the event of a determination that a printer recording material receptacle containing a printer recording material interchangeable with said installed printer recording material has been installed,
said program, additionally, executes by means of a computer a function that eliminates printer recording material held by printing means that performs printing using said printer recording material.
